(19) United States
(12) Patent Application Publication
(10) Pub. No.: US 2005/0251398 A1
(43) Pub. Date: Nov. 10, 2005

(54) Threat scanning with pooled operators

(75) Inventors: Joseph P. Zanovitch, Barton, NY (US); Tonya K. Bender, Owego, NY (US)

Correspondence Address: MILES & STOCKBRIDGE PC, 1751 PINNACLE DRIVE, SUITE 500, MCLEAN, VA, 22102-3833, US

(73) Assignee: Lockheed Martin Corporation

(21) Appl. No.: 10/837,759

(22) Filed: May 4, 2004

(51) Int. Cl. G06F 17/60

(52) U.S. Cl. 705/1

(57) ABSTRACT

A dynamically configurable threat scanning machine management system cooperates with a pooled operator image analysis unit to scan items for threats. The central control computer can transmit, among other things, operational software and threat profiles to the threat scanning machines, while the threat scanning machines can transmit, among other things, images and performance data to the central computer that can be distributed to one or more operator stations for review and analysis. The threat scanning machine management system can be arranged in a hierarchical manner, which enables threat scanning machines at various locations to be connected into regional, national or international control centers. The network may be wireless and the control computer may be portable, enabling a supervisor to remotely manage the system while remaining mobile.

Threat scanning machines are often employed in locations where safety and security are at issue. Transportation facilities, for example, airports, train stations, seaports, and the like, may employ threat scanning machines to detect security threats within passenger or freight baggage. Other facilities, such as office buildings, government buildings, court houses, museums, and the like, may also employ threat scanning machines to detect, for example, restricted items being carried by a person seeking entry to the facility. A threat scanning machine, as used herein, refers to any device capable of scanning an item to detect an object defined as a threat, or any object that combined with one or more other objects is or is capable of being a threat. A threat, as used herein, can be anything that is restricted from being brought aboard a vehicle, into a building or into an area.

Threat scanning machines may be of different make and model, including carry-on bag scanning machines, checked-bag scanning machines, walk-through metal detectors, x-ray scanners, computerized tomography devices, magnetic resonance imaging devices, cargo and freight scanners, package scanners, and the like, thus requiring individualized maintenance and control of each machine's software and data components. The task of individually maintaining and controlling each machine may be time consuming, prone to error and expensive. For example, when supervisor attention is required at a particular machine, the supervisor must physically go to the machine, assess the situation and provide guidance to the threat scanning machine operator. As another example, when the software in an existing threat scanning machine needs to be upgraded, the media containing the upgrade may be required to be carried from machine to machine in order to perform the upgrade. The diversity of threat scanning machine types and the varied locations of threat scanning machines pose obstacles to the efficient management of the threat scanning machines.

In an exemplary embodiment of the threat scanning machine management system, the threat scanning machines are connected to a communication network. One or more command and control center computers are connected to the communication network. The threat scanning machines, possibly of different make and model, are adapted with hardware and software to allow them to communicate over the network with the command and control center computer. The command and control center computer is adapted with software and/or hardware to control and manage threat scanning machines. In another exemplary embodiment of the present invention, the command and control computer can transmit data, such as, for example, operational software and threat profiles to the threat scanning machine; and the threat scanning machines may transmit data, such as, for example, images and performance data to the command and control computer. The command and control computer may then forward this information to one or more remotely located operator stations.

In yet another exemplary embodiment of the present invention, a person, such as a supervisor may view the images or performance data of a threat scanning machine remotely, for example with the assistance of the control center computer, and assess a situation and assist the threat scanning machine operator remotely, thereby permitting the supervisor to manage multiple threat scanning machines in an efficient manner. In still another exemplary embodiment of the present invention, the threat scanning machine management system may be dynamically configurable, the network may be a wireless network, and the control command and center computer may be a portable device, thus permitting a superior to manage the threat scanning machines while remaining mobile. In still another exemplary embodiment, a group of remote operators within an operator pool are used to scan and/or manipulate images associated with scanned items to check for threats.

### BRIEF DESCRIPTION OF THE DRAWINGS

FIG. 1 is a functional block diagram of an exemplary embodiment of a threat scanning machine management system;

FIG. 2 is a functional block diagram of an exemplary embodiment of a threat scanning machine management system showing the control centers connected to a threat scanning machine in accordance with the present invention;

FIG. 3 is a functional block diagram of an exemplary embodiment of a threat scanning machine management system showing the details of an exemplary threat scanning machine in accordance with the present invention;

FIG. 4 is a functional block diagram of an exemplary embodiment of a threat scanning machine management system showing the details of an exemplary control center in accordance with the present invention;

FIG. 5 is a functional block diagram of an exemplary embodiment of the logical functions of an exemplary threat management module in accordance with the present invention;

FIG. 6 is a functional block diagram of an exemplary embodiment of a remote management module in accordance with the present invention;

FIG. 7 is a functional block diagram of an exemplary embodiment of a maintenance server module in accordance with the present invention;

FIG. 8 is a functional block diagram of an exemplary embodiment of a control center database and web service connections in accordance with the present invention;

FIG. 9 is a functional block diagram of an exemplary control and maintenance system showing a web browser connection in accordance with the present invention;

FIG. 10 is a functional block diagram of an exemplary threat scanning machine architecture in accordance with the present invention;

FIG. 11 is a functional block diagram of an exemplary embodiment of the threat scanning machine management system showing an exemplary approach to network security in accordance with the present invention;

FIG. 12 is a functional block diagram of an exemplary embodiment of the threat scanning machine management system showing exemplary security components in accordance with the present invention;

FIGS. 13A and 13B are functional block diagrams of exemplary embodiments of the threat scanning machine management system showing exemplary alternative approaches to the network connection of security equipment in accordance with the present invention;

FIG. 14 is a functional block diagram of an exemplary message interface between a threat scanning machine and the threat scanning machine management system in accordance with the present invention;

FIG. 15 is an illustration of an exemplary embodiment of the threat scanning machine management system user interface showing the main menu screen;

FIG. 16 is an illustration of an exemplary embodiment of the threat scanning machine management system user interface showing the items of the Remote Management menu;

FIG. 17 is an illustration of an exemplary embodiment of the threat scanning machine management system user interface showing the items of the Threat Management menu;

FIG. 18 is an illustration of an exemplary embodiment of the threat scanning machine management system user interface showing the items of the Maintenance Server menu;

FIG. 19 is an illustration of an exemplary embodiment of the threat scanning machine management system user interface showing the items of the Threat Image Projection (TIP) Management menu;

FIG. 20 is an illustration of an exemplary embodiment of the threat scanning machine management system user interface showing Event information;

FIG. 21 is an illustration of an exemplary embodiment of the threat scanning machine management system user interface showing User Administration data;

FIG. 22 is an illustration of an exemplary embodiment of the threat scanning machine management system user interface showing a Fault Reporting selection dialog;

FIG. 23 is an illustration of an exemplary embodiment of the threat scanning machine management system user interface showing a Report Filter selection dialog;

FIG. 24 is an illustration of an exemplary embodiment of the threat scanning machine management system user interface showing System Administration data;

FIG. 25 is an illustration of an exemplary embodiment of the threat scanning machine management system user interface showing a download schedule;

FIG. 26 is an illustration of an exemplary embodiment of the threat scanning machine management system user interface showing the System Administration screen;

FIG. 27 is an illustration of an exemplary embodiment of the threat scanning machine management system user interface showing a Throughput Report;

FIG. 28 is an illustration of an exemplary embodiment of the threat scanning machine management system user interface showing a Personnel Report;

FIG. 29 is an illustration of an exemplary embodiment of the threat scanning machine management system user interface showing a Current Alarm Report;

FIG. 30 is an illustration of an exemplary embodiment of the threat scanning machine management system user interface showing an Historical Bag/Threat Information Report;

FIG. 31 is an illustration of an exemplary embodiment of the threat scanning machine management system user interface showing a Threat Type Information Report;

FIG. 32 is an illustration of an exemplary embodiment of the threat scanning machine management system user interface showing an All Actions Taken Information Report;

FIG. 33 is an illustration of an exemplary embodiment of the threat scanning machine management system user interface showing a File Management Report;

FIG. 34 is an illustration of an exemplary embodiment of the threat scanning machine management system user interface showing a Profile Management Report;

FIG. 35 is an illustration of an exemplary embodiment of the threat scanning machine management system user interface showing a Download Management Report;

FIG. 36 is an illustration of an exemplary embodiment of the threat scanning machine management system user interface showing a TIP Image Management Report;

FIG. 37 is an illustration of an exemplary embodiment of the threat scanning machine management system user interface showing a Fault Report;

FIG. 38 is an illustration of an exemplary embodiment of the threat scanning machine management system user interface adapted for use on a handheld or portable computer showing the main menu screen;

FIG. 39 is a functional block diagram illustrating an exemplary embodiment of the pooled operator configuration according to this invention; and

FIG. 40 is a flowchart illustrating an exemplary operation of the pooled operator configuration according to this invention.

### DETAILED DESCRIPTION

While the exemplary embodiments illustrated herein may show the various components of the threat scanning machine, and corresponding command and control center, collocated, it is to be appreciated that the various components of the system can be located at distant portions of a distributed network, such as a telecommunications network and/or the Internet or within a dedicated communications network. Thus, it should be appreciated that the components of the threat scanning machine, the command and control center and operator pool, respectively, can be combined into one or more devices or collocated on a particular node of a distributed network, such as a telecommunications network. As will be appreciated from the following description, and for reasons of computational efficiency, the components can be arranged at any location within a distributed network without affecting the operation of the system. Also, the exemplary embodiments shown provide a layout of the system in which the subsystems (i.e. Threat Management, Remote Management, and Maintenance Server) are shown separately for conceptual clarity and for illustrative purposes in both the threat scanning machines and the command and control center. However, it should be appreciated, that other layouts, groupings, and/or arrangements of the subsystems within the system may be used. Furthermore, while the exemplary embodiment will be discussed in relation to one or more command and control centers, it should be appreciated that the systems and methods of this invention can work equally well without a command and control center architecture. For example, the logic and accompanying hardware/software functionality of the command and control center(s) can be distributed throughout one or more of the remaining components of the architecture, such as in the threat scanning machine(s), for example, in a distributed peer-to-peer network, or the like.

Furthermore, it should be appreciated that the various links connecting the elements can be wired or wireless links, or a combination thereof, or any known or later developed element(s) that is capable of supplying and/or communicating data to and from the connected elements. Additionally, the term module as used herein can be any hardware, software of combination thereof that is capable of performing the functionality associated therewith.

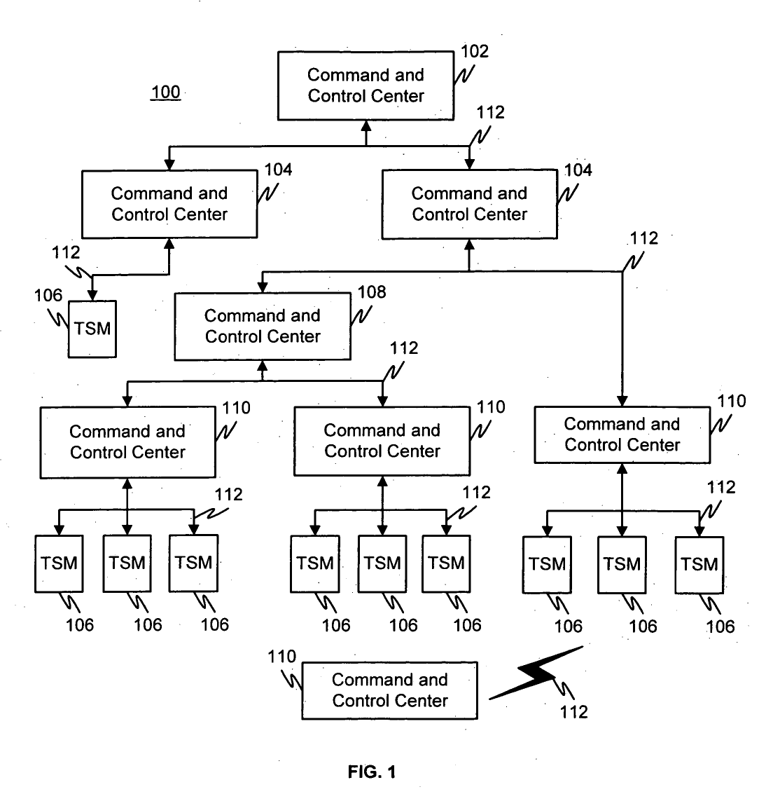

FIG. 1 shows a functional block diagram of an exemplary embodiment of a threat scanning machine management system 100. In particular, a command and control center 102 forms a top level of a system hierarchy and is interconnected by a network 112 to a next level comprising command and control centers 104. A command and control center 104 is interconnected with a threat scanning machine 106 by the network 112. A command and control center 104 is interconnected to command and control center 108 and to command and control center 110 via the network 112. A command and control center 110 is interconnected to one or more threat scanning machines 106 via the network 112.

The threat scanning machine management system 100 shown in FIG. 1 represents, for purposes of illustration, an exemplary configuration of command and control centers connected to each other and to threat scanning machines. However, it should be appreciated that the system 100 can be configured in order to be adaptable to various contemplated uses of the present invention. The configuration of the system 100 may be static or dynamic depending on contemplated uses of the invention. In an exemplary embodiment, a transportation facility may have an existing network (not shown), and in such a case, the threat scanning machine management system 100 may be adapted to the existing network. Alternatively, in another exemplary embodiment, if an existing network within a transportation facility is insufficient to be able to be adapted to meet the communications requirements of the threat scanning machine management system 100 for any reason, such as low bandwidth or poor security, for example, then a new network can be installed for the threat scanning machine management system 100 to communicate over. However, it should be appreciated that any communications medium that allows the threat scanning machines and the control centers to communicate may be used with equal success. In an exemplary embodiment of the invention, the command and control centers and the threat scanning machines communicate over the network 112 using standard protocols common in the industry. Examples of standard protocols include, for example, hypertext transfer protocol (HTTP), Internet Inter-ORB Protocol (IIOP), Remote Method Invocation (RMI), Simple Mail Transfer Protocol (SMTP), Secured Sockets Layer (SSL), Secure Hypertext Transfer Protocol (SHTTP) and the like. Examples of a network 112 include wired or wireless solutions such as Ethernet, fiber optic, or the like. However, it should be appreciated that any present or future developed networks and/or network protocols which perform the tasks required for a command and control center to communicate with a threat scanning machine may be used with equal success according to the present invention.

In operation, the exemplary command and control center 110 communicates with one or more threat scanning machines 106 via the network 112. The command and control center 110 may transmit data-to the threat scanning machine, for example, operational software, authorized users and credentials, threat profiles, etc. The operational software may comprise any combination of software for the operation of the scanning system and/or software for the operation of the management system 100. The authorized users and credentials may include, for example, a list of user login names and passwords. Threat profiles may include data that the threat scanning machine uses to aid in identification of threats, for example the shape of potential threat items, and/or the physical properties of an item that may indicate a potential threat. However, it should be appreciated that the data transmitted from the command and control center 110 to the threat scanning machine 106 may be any data required for the management and operation of the threat scanning machine 106 and could be used with equal effectiveness according to the present invention.

The exemplary threat scanning machine 106 communicates with the command and control center 110. The threat scanning machine 106 may receive data from the command and control center 110 and/or may transmit data to the command and control center 110. The data that the threat scanning machine may transmit to the command and control center 110 may include, for example, performance data, requests for operator assistance, threat detection data, and/or the like.

The exemplary command and control center 110 may communicate with one or more command and control centers 104 and/or 102. In the exemplary embodiment shown in FIG. 1, the command and control centers 110 are interconnected to command and control centers 104. The command and control centers 104 are interconnected to command and control center 102. In this exemplary embodiment and configuration of the present invention control centers are arranged in a hierarchical manner to provide for the centralized management of many threat scanning machines 106 from a central command and control center 102, thus providing more efficient management of the threat scanning machines 106.

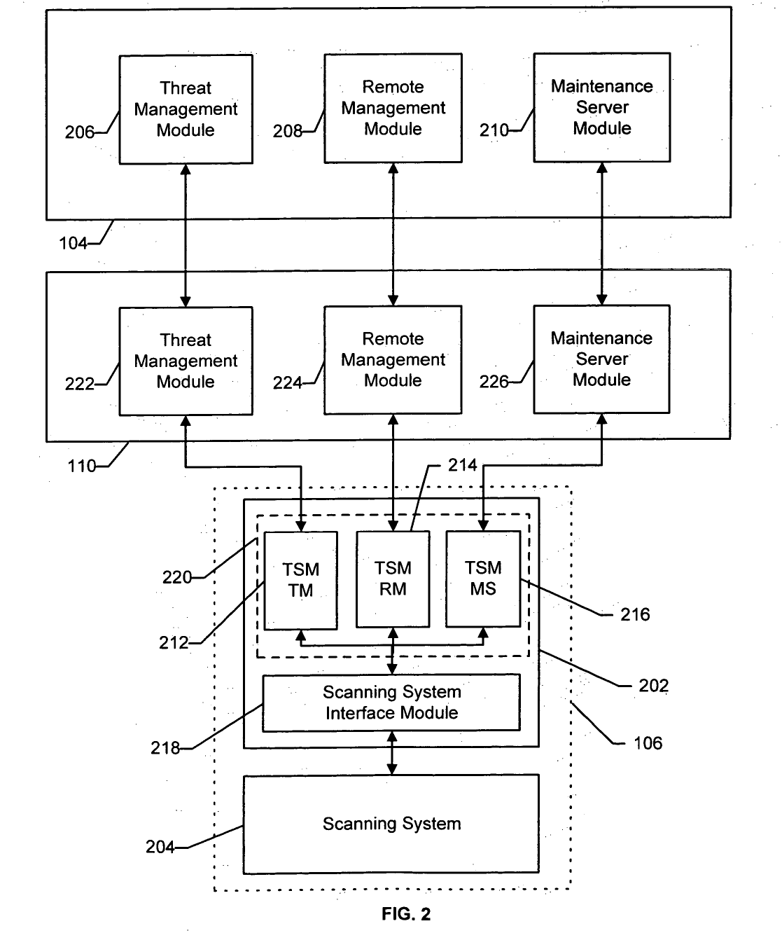

FIG. 2 is a functional block diagram of an exemplary embodiment of a threat scanning machine management system. In particular, a command and control center 104 at one level is interconnected with a command and control center 110 of another level. The command and control center 104 comprises, in addition to standard control center components, a threat management module 206, a remote management module 208 and a maintenance server module 210. The exemplary command and control center 110 comprises, in addition to standard control center components, a threat management module 222, a remote management module 224 and a maintenance server module 226. The exemplary command and control center 110 is interconnected to one or more exemplary threat scanning machines 106. The exemplary threat scanning machines 106 comprise, in addition to standard threat scanning machine components, a threat scanning machine computer 202 and a scanning system 204.

The exemplary threat scanning machine computer 202 comprises, in addition to standard computer hardware and software components, a management system interface module 220 and a scanning system interface module 218. The management system interface module 220 comprises a threat management module 212, a remote management module 214, and a maintenance server module 216. The exemplary threat management module 212, remote management module 214, and maintenance server module 216 are adapted to provide the interface and logic necessary for the threat scanning machine 106 to be connected to the threat scanning machine management system 100; these modules also communicate with the scanning system interface module 218. In an exemplary embodiment, the threat scanning machine computer 202 may be a standard PC. In another exemplary embodiment, the threat scanning machine computer 202 may be a specialized computer adapted specifically to control the threat scanning machine 106.

In yet another exemplary embodiment of the present invention, the threat scanning machine management system 100 may be designed to adapt to any existing threat scanning machine computer 202 in order to allow the threat scanning machine 106 to connect and communicate within the threat scanning machine management system.

In still another exemplary embodiment of the present invention, the management system interface module 220 can be housed in a computer separate from the threat scanning machine computer 202; this construction may be useful in situations where the execution of the management system interface module 220 may present too great a processing and/or communications burden for the threat scanning machine computer 202.

In operation, the exemplary threat management module 206 of the command and control center 104 communicates with the threat management module 222 of the command and control center 110. The threat management module 222 of the command and control center 110 communicates with the threat management module 212 of the threat scanning machine 106. The threat management information comprises any information related to the management of threats. Examples of such information include Threat Image Projections (TIPs), which are non-threat images with threats inserted into them for testing purposes, threats detected within a particular piece of baggage, or messages alerting the threat scanning machine operators to specific or general types of security risks that may be present or that may be attempted.

The exemplary remote management module 208 of the command and control center 104 communicates with the remote management module 224 of the command and control center 110. The remote management module 224 of the command and control center 110 communicates with the remote management module 214 of the threat scanning machine 106.

The exemplary maintenance server module 210 of the command and control center 104 communicates with the maintenance server module 226 of the command and control center 110. The maintenance server module 226 of the command and control center 110 communicates with the maintenance server module 216 of the threat scanning machine 106.

The command and control center 110 and the threat scanning machine 106 may communicate with each other using a predefined interface format. A predefined format allows for the command and control center 110 to be connected to any threat scanning machine 106 that has been adapted to work in accordance with the present invention. The tables below provide an example of a predefined interface between the command and control center 110 and the threat scanning machine 106. However, it should be appreciated that these tables merely represent an exemplary interface for illustration purposes. An actual interface may vary in both content and design, while still being used with equal success, depending on contemplated uses of the invention.

TABLE 1
Interface Message

Operator Bag Information
Screener Bag Information
Threat Information
Alarm Information
TIP Truth Information
Event Information
User Keystroke Information
TIP Configuration
Threat Detection Configuration

Table 1 shows the messages of an exemplary interface between the command and control center 110 and the threat scanning machine 106. In this exemplary interface the threat scanning machine 106 transmits messages to the command and control center 110, including, for example, Operator Bag Information, Screener Bag Information, Threat Information, Alarm Information, Threat Image Projection (TIP) Truth Information, Event Information, and/or User Keystroke Information. While the command and control center 110 transmits the TIP Configuration and Threat Detection Configuration messages to the threat scanning machine 106.

TABLE 2
Operator Bag Information

| Field Name | Description |
|---|---|
| Machine ID | Unique Identifier of Threat Scanning Machine |
| Bag ID | Identification of the bag |
| TIP ID | Identification of the TIP image |
| Logon ID | Operator ID |
| Bag Start Date CT | Date bag entered CT (Computerized |
| | Tomography) |
| Bag Start Time CT | Time bag entered CT |
| Bag Start Date QR | Date bag entered QR (Quadrupole Resonance) |
| Bag Start Time QR | Time bag entered QR |
| Operator Start Date CT | Date operator received the image |
| Operator Start Time CT | Time operator received the image |
| Operator End Date CT | Date operator completed the transaction |
| Operator End Time CT | Time operator completed the transaction |
| Bag Size | Length and/or weight of bag |
| Number of Threats | Number of threats detected in this bag |
| Number of Keystrokes | Number of keystrokes used by operator |
| Machine Decision | Machine indication of possible threat present |
| | within bag |
| Operator Decision | Operator indication of possible threat present |
| | within bag |
| Image ID | File name if cannot be derived from Bag ID |

Table 2 shows the contents of an exemplary Operator Bag Information message. The Operator Bag Information message provides the command and control center 110 with information relating to a particular piece of baggage that has been scanned by the threat scanning machine 106.

In operation, the Operator Bag Information message is used to transmit information gathered by an operator on a particular bag. A supervisor or screener can review the Operator Bag Information message in assisting the operator in assessing a potential threat. Another use of the Operator Bag Information message may be to monitor the performance of an operator by placing a test bag containing a known threat or threat-like object in order to evaluate the operator's performance in identifying and assessing the potential threat. A further use of the Operator Bag Information message is to collect the messages over time in order to form statistical models of the operator bag information. These statistical models may then be used to further enhance the operation of the threat scanning machine management system.

TABLE 3
Screener Bag Information

| Field Name | Description |
|---|---|
| Machine ID | Unique Identifier of Threat Scanning Machine |
| Bag ID | Identification of the bag |
| Logon ID | Screener ID |
| Screener Start Date CT | Date screener received the image |
| Screener Start Time CT | Time screener received the image |
| Screener End Date CT | Date screener completed the transaction |
| Screener End Time CT | Time screener completed the transaction |
| Number of Keystrokes | Number of keystrokes used by screener |
| Screener Decision | Determination of possible threat within bag |
| Screener Annotation | Screener's notes |

Table 3 shows the contents of an exemplary Screener Bag Information message. The Screener Bag Information message provides the command and control center 110 with information from a particular screener about a particular piece of baggage.

In operation, when a threat scanning machine and/or operator detect a potential threat, a screener may be called upon to search the bag physically. The Screener Bag Information message is used to transmit information gathered by a Screener on a particular bag, such as the results of the physical search, threats found or not found, and any action taken by security with regard to the passenger or the baggage. A supervisor can review the Screener Bag Information in assisting the screener and operator in assessing and dealing with a potential threat. Another use of the Screener Bag Information message may be to monitor the performance of a screener by placing a test bag containing a known threat or threat-like object in order to evaluate the screener's performance in identifying and assessing the potential threat. A further use of the Screener Bag Information message is to collect the messages over time and correlate them with other system data, such as operator bag messages, in order to form statistical models of the screener bag information. These statistical models may then be used to further enhance the operation of the threat scanning machine management system.

An important aspect of the present invention, achieved through the operator and screener bag information messages, is that baggage may be tracked and associated with a particular person as that person moves about from place to place. For example, the information about a particular person's bag may be gathered as the person travels from location to location. The threat scanning can then be augmented with historical bag information data in order to further inform the operator, screener, or supervisor of the need for further inspection of the bag. Additionally, the baggage may be associated with an owner or carrier and vice versa, thereby permitting the threat scanning machine management system to enhance the threat scanning with auxiliary information about the owner or carrier to further enhance the security.

TABLE 4
Threat Information

| Field Name | Description |
|---|---|
| Machine ID | Unique Identifier of Threat Scanning Machine |
| Bag ID | Identification of the bag |
| CT Compound Type | Detected compound type |
| CT Mass | Measured mass/density |
| CT Confidence | Algorithm confidence factor |
| QR Compound Type | Detected compound type |
| QR Mass | Detected mass |
| Viewed by operator | Identifies if operator viewed this particular threat |
| Operator Action | Identifies what action the operator took on a given |
| | threat |
| Machine Decision | Machine decision of threat/non-threat |
| Threat Category | Identifies category of threat (e.g. weapon, |
| | explosive, etc.) |
| Picture File Name | The name of the file containing the picture |

Table 4 above shows the contents of an exemplary Threat Information message. The Threat Information message provides the command and control center 110 with information about a particular threat detected by the threat scanning machine 106.

In operation, Threat Information messages may be transferred to the command and control center for assistance in assessment by a supervisor. Additionally, the supervisor in the command and control center may pass the message along to a more senior supervisor at a regional or national level command and control center. Further still, the system can be configured to automatically forward messages to higher levels in the hierarchy based on preselected or dynamic criteria, such as threat type or threat category. In this manner a threat that once could only be viewed and assessed on site, may now be able to be assessed by numerous people with possibly increasing levels of expertise, thereby by making efficient use of the supervisor's time through a hierarchical system of review and assessment of potential threats. This process can be carried out in a very expeditious manner through the interconnection of the threat scanning machine and the command and control centers on a distributed network. A further use of the Threat Information message is for the threat management system as a whole to scan for incidents of like or similar threats and alert supervisors and threat scanning machine operators to patterns in the data which may indicate a security breach is being attempted. Still another use of the Threat Information message is to gather information on things that have been identified as threats, but in actuality are only items of interest for purposes other than security. For example, the threat scanning machine could possibly be configured to monitor for aerosol cans within baggage and record statistics related to their occurrence in the baggage. This type of statistical information on “threats” could be used to guide policies regarding acceptable items, for general research into items in baggage, or for other such purposes. In yet another use of the Threat Information messages, the data may be collected over time and used to build statistical models of potential threats and their rates of occurrence. These statistical models could be fed back into the threat management system in order to improve the accuracy, security, and management efficiency of the threat scanning machine management system.

TABLE 5
Alarm Information

| Field Name | Description |
|---|---|
| Machine ID | Unique Identifier of the Threat Scanning Machine |
| Bag ID | Identification of the bag |
| Alarm Severity | Identifies the severity of the alarm (e.g. nail |
| | clippers may be low, scissors may |
| | be medium, and gun/knife may be high) |
| Threat Category | Identifies category of threat (e.g. weapon, explosive, |
| | etc.) |
| Threat Confirmed | Annotation indicating if a threat was actually found |

Table 5 shows the contents of an exemplary Alarm Information message. The Alarm Information message provides the command and control center 110 with information about a particular alarm from the threat scanning machine 106.

In operation, the Alarm Information messages provide information useful to achieving management goals. As a current situational awareness indication, the Alarm Information may be transferred both vertically (i.e. from threat scanning machine to command and control center and on up the chain of command and control centers) and horizontally (i.e. threat scanning machine to threat scanning machine) in order to inform management and other operators of threat events in a real time manner. This real-time reporting of threat event information makes an added dimension in security response possible, namely one of recognizing a looming security risk that may be geographically disbursed. By utilizing threat scanning machine management systems in multiple countries it would even be possible for nations to collectively detect and recognize a global security threat event that was in the early stages of being carried out. By collecting Alarm Information messages over time, statistical trends may be analyzed to aid management in improving the efficiency and security of the threat scanning machines.

TABLE 6
Event Information

| Field Name | Description |
|---|---|
| Machine ID | Unique Identifier of the Threat Scanning Machine |
| Logon ID | User ID |
| Event Date CT | Date event happened |
| Event Time CT | Time event happened |
| Event Code | Code responding to event |
| Event Detail | Text message about event |

Table 6 shows the contents of an exemplary Event Information message. The Event Information message provides the command and control center 110 with information about a particular event that occurred at a threat scanning machine 106.

In operation the Event Information messages provide information useful to achieving management goals. As a current situational awareness indication, the Event Information message may be transferred both vertically (i.e. from threat scanning machine to command and control center and on up the chain of command and control centers) and horizontally (i.e. threat scanning machine to threat scanning machine) in order to inform management and other operators of threat events in a real-time manner. This real-time nature of the reporting of threat event information brings a new dimension in security response, namely one of recognizing a looming security risk that may be geographically distributed. By collecting Event Information messages over time, statistical trends may be analyzed to aid management in improving the efficiency and security of the threat scanning machines.

TABLE 7
User Keystroke Information

| Field Name | Description |
|---|---|
| Machine ID | Unique Identifier of the Threat Scanning Machine |
| Logon ID | User ID |
| Bag ID | Identification of the bag |
| Keystroke Count | Number of keystrokes |
| Keystroke 1 | Keystroke code |
| Timestamp 1 | Time keystroke occurred |
| Keystroke 2 | Keystroke code |
| Timestamp 2 | Time keystroke occurred |
| . | . |
| . | . |
| . | . |
| Keystroke n | Keystroke code |
| Timestamp n | Time keystroke occurred |

Table 7 shows the contents of an exemplary User Keystroke Information message. The User Keystroke Information message provides the command and control center 110 with details from the threat scanning machine 106 regarding the keystrokes of a user in the processing of a particular piece of baggage.

In operation, the User Keystroke Information message can be used for several management and supervisory purposes. The keystroke information may be used as a training aid by permitting supervisor to oversee the keystrokes used by a scanning machine operator and determine if the operator has used the scanning effectively, or if further training is needed in a particular area. Further, the keystroke information may be collected over time to study the efficiency of the threat scanning machine operators. Further still, the keystroke information may provide additional details to a supervisor who is assisting a scanning machine operator with a possible threat presence. Yet another use of the keystroke information may be to correlate the keystroke information with the image data and recreate, or playback, what took place at a particular machine to look for suspicious activity by the operator or as an aid in analyzing machine performance and debugging the threat scanning machine software.

An important aspect of the threat scanning machine management system is that it is capable of managing both the threat scanning machine equipment and the personnel operating the threat scanning machines.

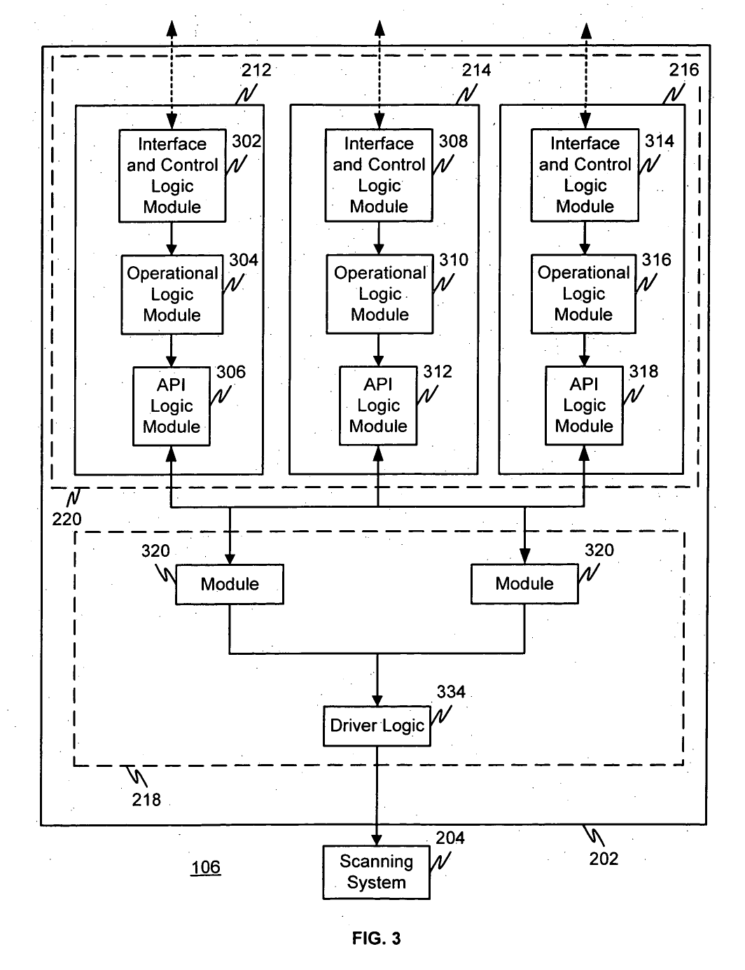

FIG. 3 is a functional block diagram of an exemplary threat scanning machine 106. In particular, the threat scanning machine 106 comprises, in addition to the standard threat scanning machine components, a computer 202 and a scanning system 204. The computer 202 comprises, in addition to standard computer components, a management system interface module 220 and a scanning system interface module 218. The management system interface module 220 comprises a threat management module 212, a remote management module 214, and a maintenance server module 216. The scanning system interface module 218 comprises one or more interface modules 320, and, optionally, a low level driver module 334. The threat management module 212 comprises an interface and control logic module 302, an action logic module 304, and an Application Programming Interface (API) logic module 306. The remote management module 214 comprises an interface and control logic module 308, an action logic module 310 and an API logic module 312. The maintenance server module 216 comprises an interface and control logic module 314, an operational logic module 316, and an API logic module 318.

In operation, the threat scanning machine computer 202 executes the management system interface module 220 and the threat scanning machine physical machine interface software 218.

The exemplary interface and control logic module 302 contains the logic necessary for the connection and communication with the threat management module within the control computer. The Operation Logic module 304 contains operational logic. The application programming interface (API) module 306 contains the logic necessary for interfacing with the scanning system interface module 218.

The remote management module 214 contains an interface and control logic module 308 that contains the logic necessary for the connection and communication with the remote management module in a command and control center. The operational logic module 310 contains operational logic and an application programming interface (API) component 312 that contains the logic necessary for interfacing with the scanning system interface module 218.

The interface and control logic module 314 contains the logic necessary for the connection and communication with the maintenance server module in the command and control center. Also within the threat scanning machine maintenance server module 216 is an operational logic module 316 that contains operational action logic and an application programming interface (API) component 318 that contains the logic necessary for interfacing with the scanning system interface module 218.

An exemplary embodiment of the scanning system interface module 218 is shown in FIG. 3. In particular, the scanning system interface module 218 may contain one or more modules 320. These modules 320 may provide interface logic necessary for the management system interface module 220 to be interconnected with and/or to control the scanning system 204. The modules 320 may, for example, provide user interface functionality to the threat scanning machine 106 operator. In another exemplary embodiment of the invention, the operator interface module 320 may reside within the management system interface module 220. Examples of interface modules 320 include weapons processing, explosive processing, data archiving, diagnostics, image capture, material movement system, and/or the like. In addition, the scanning system interface module 218 also may contain a low-level driver module 334 adapted to directly control the circuitry, software, and/or mechanics of the scanning system 204. It should be appreciated that the threat scanning machine 106 shown in FIG. 3 is an exemplary embodiment shown for illustration purposes, and any threat scanning machine can be utilized within the threat scanning machine management system 100 with equal success. The exact software component configuration of a particular threat scanning machine 106 will depend on its contemplated use and the capabilities of its subsystems, in accordance with the present invention.

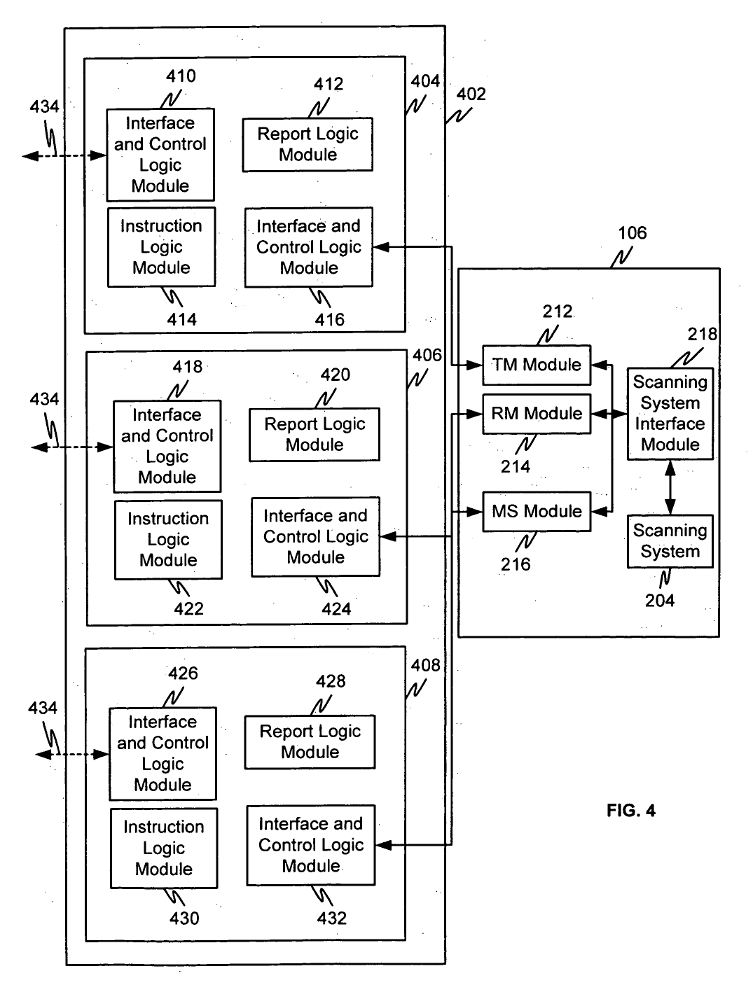

FIG. 4 is a functional block diagram of an exemplary embodiment of the control center computer side of an exemplary threat scanning machine management system 100. In particular, the command and control center software 402 comprises, in addition to standard control center software components, a threat management module 404, a remote management module 406, and a maintenance server module 408.

The threat management module 404 comprises an interface and control logic module 410, a report logic module 412, an instruction logic module 414, and a threat scanning machine receive and control logic module 416.

The remote management module 406 comprises an interface and control logic module 418, a report logic module 420, an instruction logic module 422, and a threat scanning machine receive and control logic module 424.

The maintenance server module 408 comprises an interface and control logic module 426, a report logic module 428, an instruction logic module 430, and a threat scanning machine receive and control logic module 432. In an exemplary embodiment, the interface and control logic modules (302, 308, and 314 ) of the threat scanning machine 106 may be similar to the interface and control logic modules (410, 418, and 426 ) of the command and control center 110.

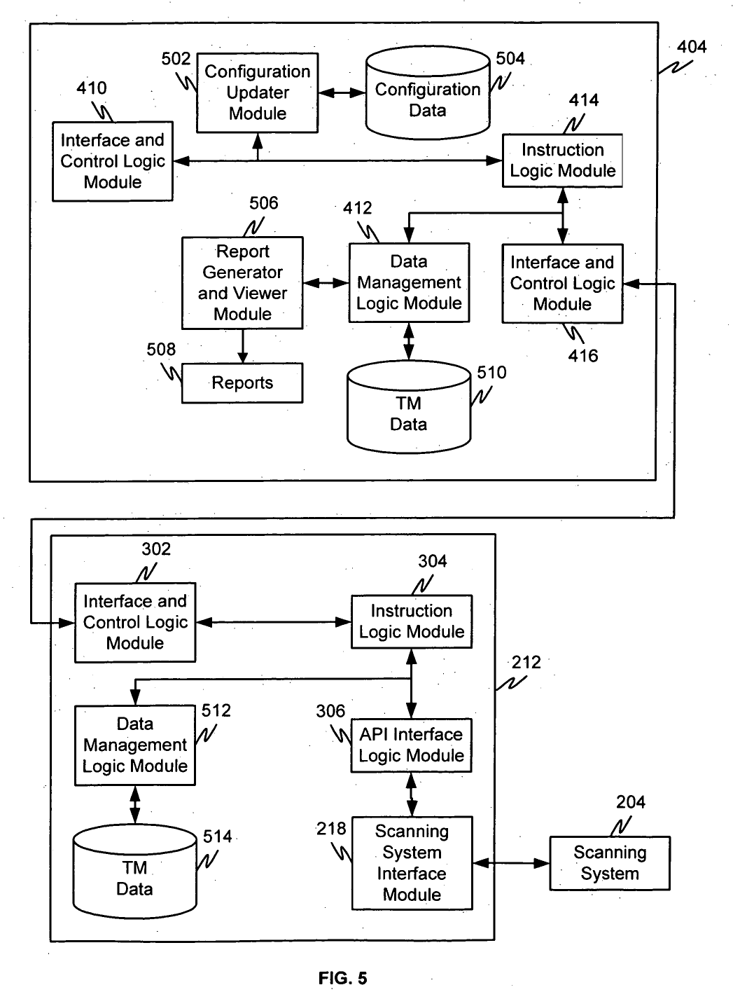

FIG. 5 is a functional block diagram of an exemplary embodiment of a threat management module in accordance with the present invention. In particular, a command and control center threat management module 404 is shown connected to a threat scanning machine threat management module 212. The command and control center threat management module 404 comprises an interface and control logic module 410, a configuration updater 502, a configuration database 504, a report generator and viewer module 506, one or more reports 508, an instruction logic module 414, a data management logic module 412, threat management database 510 and interface and control logic module 416. The threat scanning machine threat management module 212 comprises an interface and control logic module 302, an instruction logic module 304, a data management logic module 512, a threat management database 514, an API interface logic module 306, and a scanning system interface module 218.

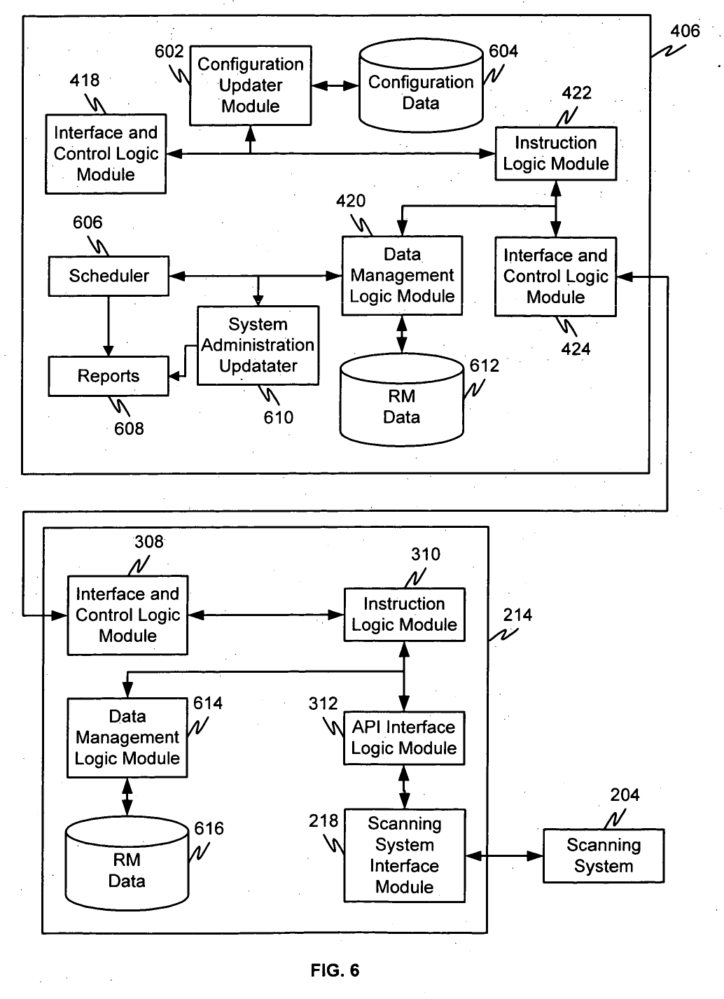

FIG. 6 is a functional block diagram of an exemplary embodiment of a remote management module in accordance with the present invention. In particular, a command and control center remote management module 406 is shown connected to a threat scanning machine remote management module 214. The command and control center remote management module 406 comprises an interface and control logic module 418, a configuration updater 602, a configuration database 604, a scheduler 606, a system administration updater 610, one or more reports 608, an instruction logic module 422, a data management logic module 420, remote management database 612 and interface and control logic module 424. The threat scanning machine remote management module 214 comprises an interface and control logic module 308, an instruction logic module 310, a data management logic module 614, a remote management database 616, an API interface logic module 312, and a scanning system interface module 218.

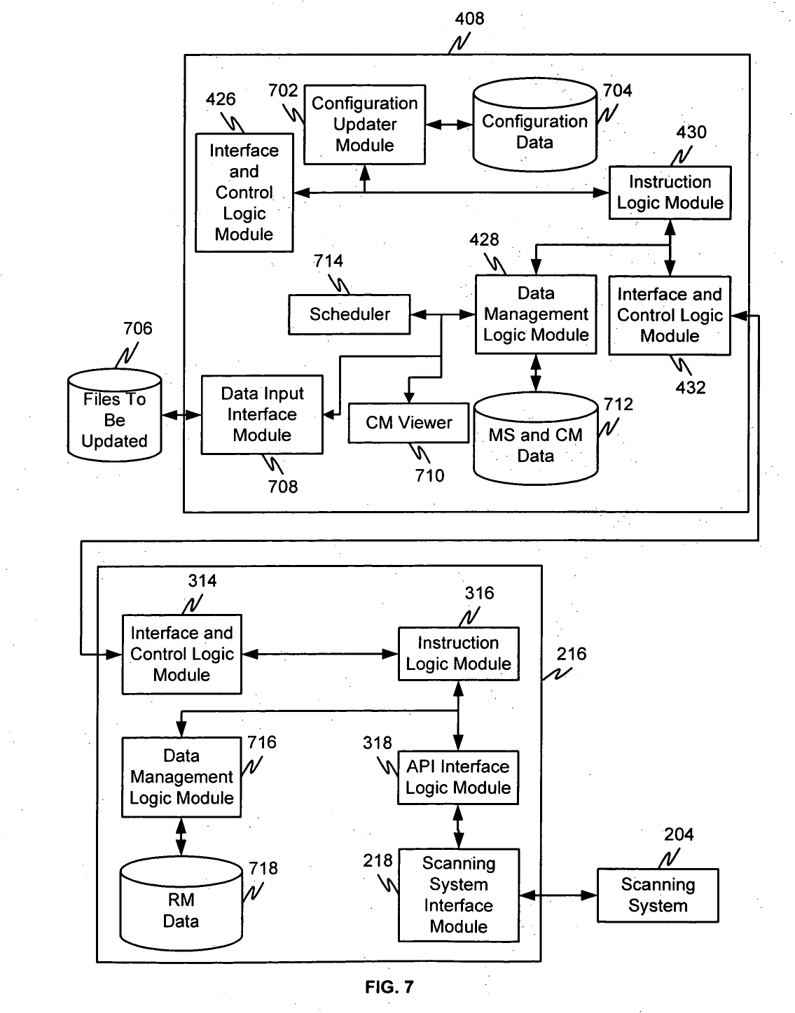

FIG. 7 is a functional block diagram of an exemplary embodiment of a maintenance server module in accordance with the present invention. In particular, a command and control center maintenance server module 408 is shown connected to a threat scanning machine maintenance server module 216. The command and control center maintenance server module 408 comprises an interface and control logic module 426, a configuration updater 702, a configuration database 704, a configuration management viewer 710, a data input interface 708, one or more data files 706, an instruction logic module 430, a data management logic module 428, maintenance server and configuration database 712, a scheduler module 714 and an interface and control logic module 432. The threat scanning machine threat management module 216 comprises an interface and control logic module 314, an instruction logic module 316, a data management logic module 716, a maintenance server database 718, an API interface logic module 318 and a scanning system interface module 218.

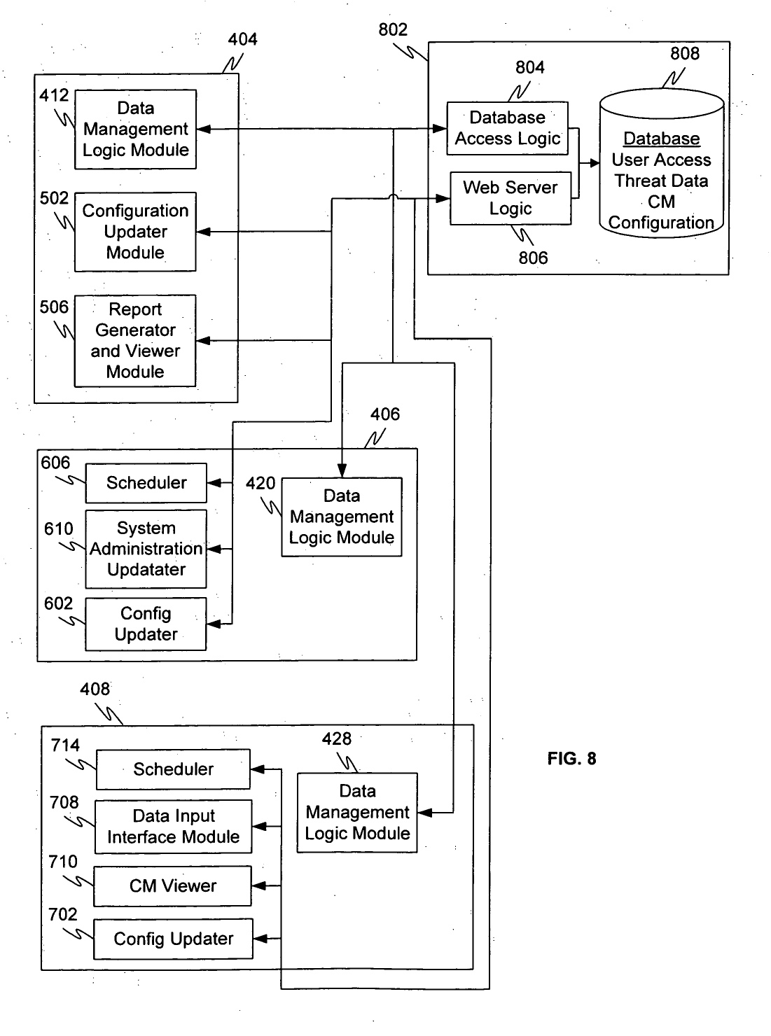

FIG. 8 is a functional block diagram of an exemplary embodiment of a control center database and web service connections in accordance with the present invention. In particular, the threat scanning machine management system 100 data store 802 comprises a database access logic module 804, a web server logic module 806 and a database 808. The data management logic modules 412, 420, and 428 of the threat management, remote management, and maintenance server modules, respectively, are connected to the database access logic module 804. The report generator and viewer 506 and the configuration updater 502 of the threat management module 404 are connected to the web server logic module 806. The system administration updater 610, the scheduler 606 and the configuration updater 602 of the remote management module 406 are connected to the web server logic module 806. The configuration management viewer 710, the scheduler 714, the data input interface 708 and the configuration updater 702 of the maintenance server 408 are connected to web server logic module 806. The web server logic module 806 is connected to the database 808.

In operation, the data management logic modules 412, 420, and 428 of the threat management, remote management, and maintenance server modules respectively communicate with the database access logic module 804. The database access logic module provides the interface connectivity to the database 808. The web server logic module 806 provides the command and control center with web service access to the database 808.

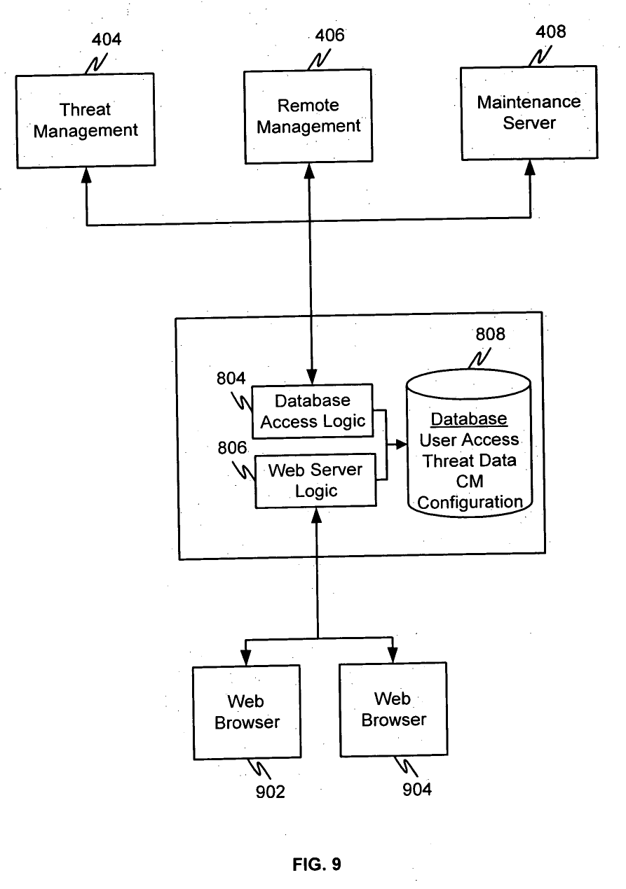

FIG. 9 is a functional block diagram of an exemplary control and maintenance system showing a web browser connection in accordance with the present invention. In particular, web browsers 902 and 904 are shown connected to the web server logic module 806. While two web browsers are shown, it should be appreciated that multiple web browsers may connect to the web server logic module 806.

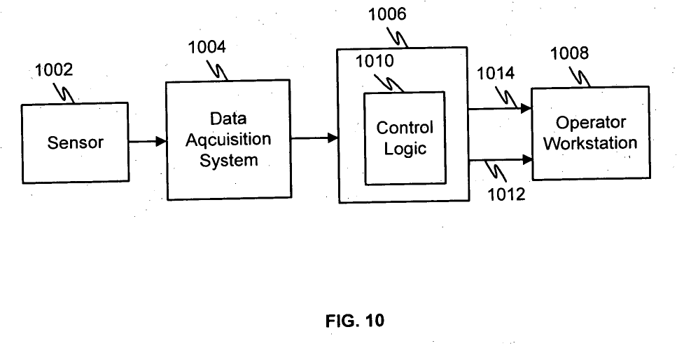

FIG. 10 is a functional block diagram of an exemplary threat scanning machine architecture. In particular, the threat scanning machine comprises a sensor 1002, a data acquisition system 1004, a reconstruction computer 1006, and an operator workstation 1008. The reconstruction computer 1006 comprises a control logic module 1010. The operator workstation 1008 presents a graphical user interface to the operator of the threat scanning machine.

In operation, raw data from the sensor 1002 is collected by the data acquisition system 1004. The raw data is then transmitted to the reconstruction computer 1006. The reconstruction computer 1006 processes the raw data and may provide a three-dimensional image 1014 or a two-dimensional image 1012 to the operator workstation 1008. In a threat scanning machine adapted for use with the threat scanning machine management system 100, the software for the threat scanning machine management system 100 resides on the operator workstation 1008. The threat scanning machine management system 100 can download software or data to the reconstruction computer 1006, operator workstation 1008, and/or other components of the threat scanning machine that may require software or data to operate.

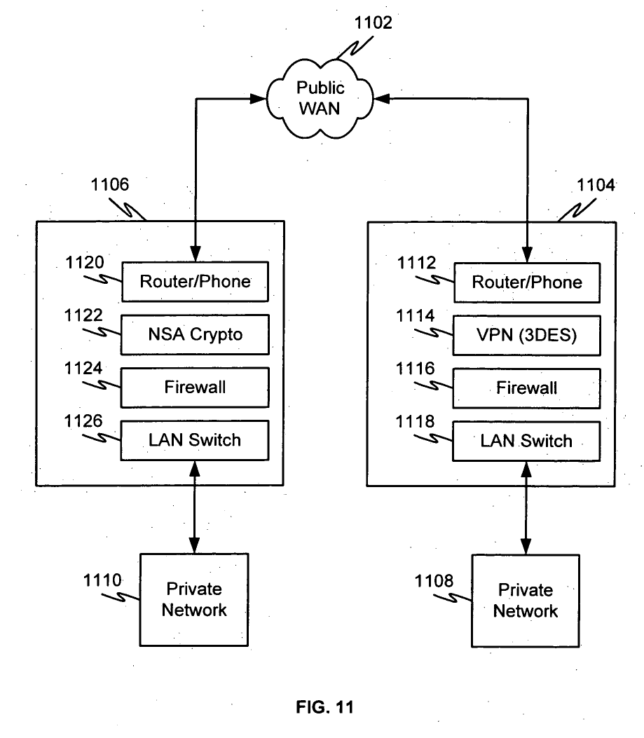

FIG. 11 is a functional block diagram of an exemplary embodiment of the threat scanning machine management system showing an exemplary approach to network security for two different levels of security, confidential and secret. In particular, the public network 1102, for example a wide area network (WAN), is connected to both a confidential communications system 1104 and a secret communications system 1106. The confidential communications system comprises a router 1112, a triple data encryption standard (3DES) virtual private network connection 1114, a firewall 1116 and a local area network (LAN) switch 1118. An exemplary private network 1108 is connected to the LAN switch 1118. The secret communications system 1106 comprises a router 1120, a National Security Agency (NSA) cryptographic processor 1122, a firewall 1124, and a LAN switch 1126. A private network 1110 is connected to the LAN switch 1126.

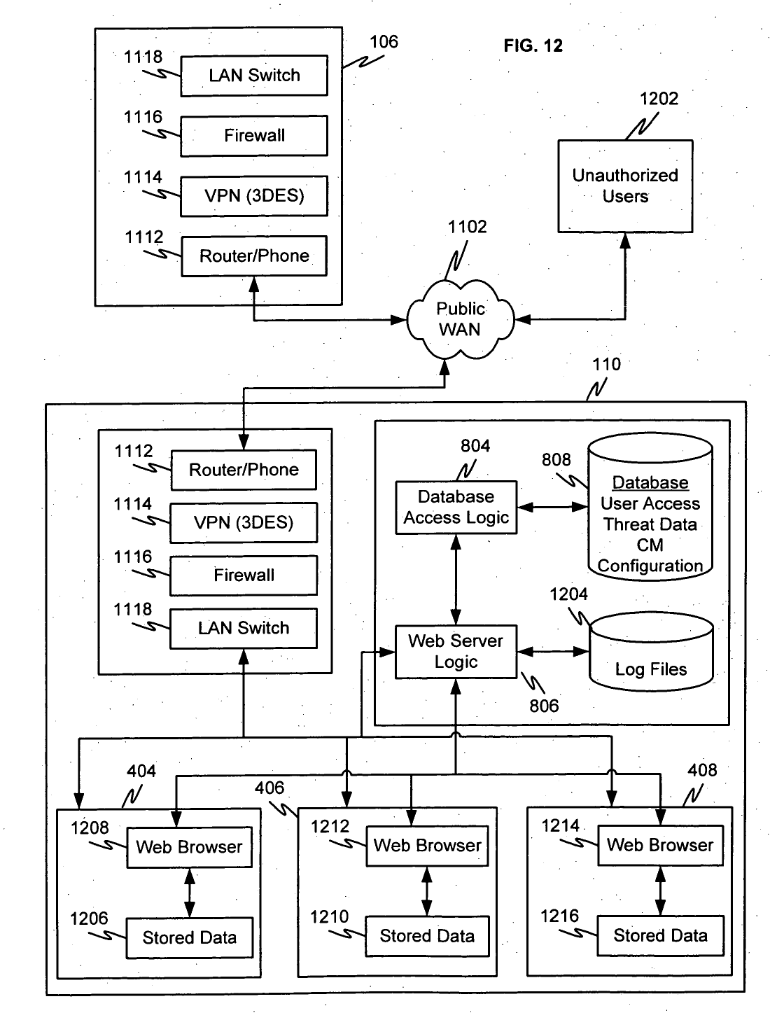

FIG. 12 is a functional block diagram of an exemplary embodiment of the threat scanning machine management system showing exemplary security components in accordance with the present invention. In particular, a threat scanning machine 106 is connected to the public wide area network (WAN) 1102. A command and control center 110 is also connected to the public WAN 1102. Unauthorized users 1202 may be connected to the public wide area network. The threat scanning machine communications system comprises a router/phone 1112, an encryption module 1114 or 1120 depending on the level of security, a firewall 1116, and a local area network (LAN) switch 1118. The command and control center 110 comprises a threat management module 404, a remote management module 406, a maintenance server module 408, a web server logic module 806, log files 1204, a database 808, a router/phone 1112, an encryption device 1114 or 1120 depending on the level of security required, a firewall 1116 and a LAN switch 1118.

In operation, the unauthorized users 1202 are restricted from accessing the threat scanning machine 106 or the command and control center 110. While the encryption devices 1114 or 1120, permit the threat scanning machine 106 and the command and control center 110 to communicate in a secure manner.

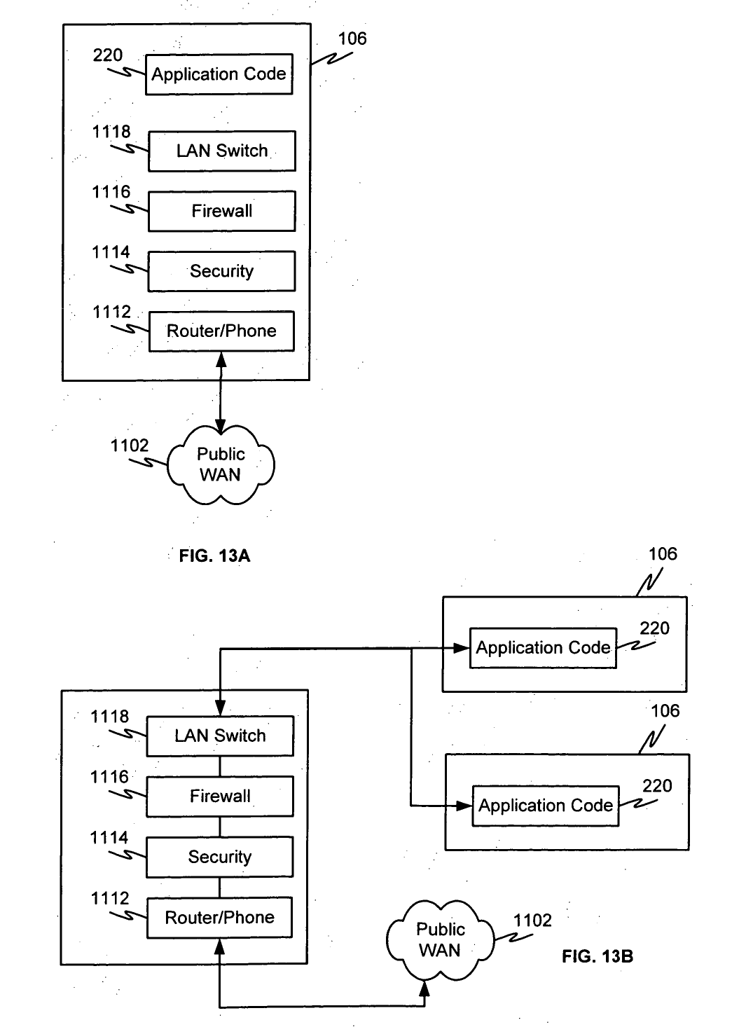

FIG. 13 is a functional block diagram of an exemplary embodiment of the threat scanning machine management system showing exemplary alternative approaches to the network connection of security equipment in accordance with the present invention. In particular, FIG. 13 shows two approaches to network security within a transportation facility. In FIG. 13A, the threat scanning machine 106 requires the security hardware and software to be present within the threat scanning machine. In FIG. 13B, there is one set of security hardware and software for an entire facility and the threat scanning machines 106 are all interconnected to the one set of communications security hardware and software.

In FIG. 13A, the threat scanning machine comprises application code 220, a local area network switch 1118, a firewall 1116, an encryption device 1114 or 1120 depending on the level of security required, and a router/phone 1112. In operation the threat scanning machine 106 containing its own set of communications security hardware and software is able to be directly connected to the public wide area network 1102.

In FIG. 13B, the communications security hardware and software may be placed in a central location and accessed by one or more threat scanning machines 106. The communications equipment comprises a local area network switch 1118, a firewall 1116, an encryption device 1114 or 1120 depending on the level of security required, and a router/phone 1112. The threat scanning machines 106 each contain their own application code 220. The threat scanning machines 106 are interconnected to the communications security equipment via the LAN switch 1118.

In operation, each threat scanning machine 106 communicates through the LAN switch 1118 to the communications security hardware and software in order to access the public wide area network 1102.

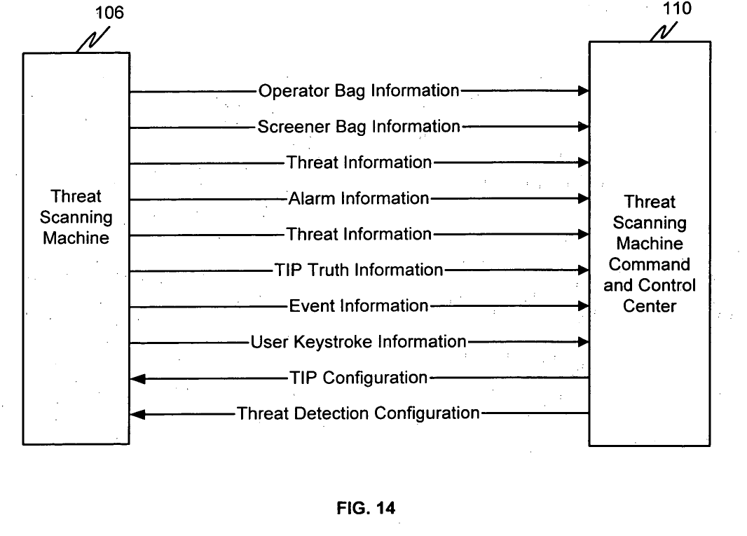

FIG. 14 shows a functional block diagram of a threat scanning machine 106 interconnected with a command and control center 110. In particular, FIG. 14 shows an exemplary message interface between the threat scanning machine 106 and the command and control center 110 in accordance with the messages described in Tables 1 through 7 above.

In operation, the threat scanning machine 106 provides the following message to the command and control center 110: operator bag information, the screener bag information, the threat information, alarm information, TIP truth information, event information, and user keystroke information. The command and control center 110 provides the following messages to the threat scanning machine 106, TIP configuration and threat detection configuration.

One way that the personnel using a threat scanning machine management system can interact with the system is through computer adapted to provide a graphical user interface. The following is a description of an exemplary graphical user interface in accordance with the present invention. However, it should be appreciated that the graphical user interface shown in the figures is provided for illustrative purposes. A particular embodiment of the invention may have a graphical user interface that is implemented, configured, or adapted differently depending on the contemplated uses of the invention.

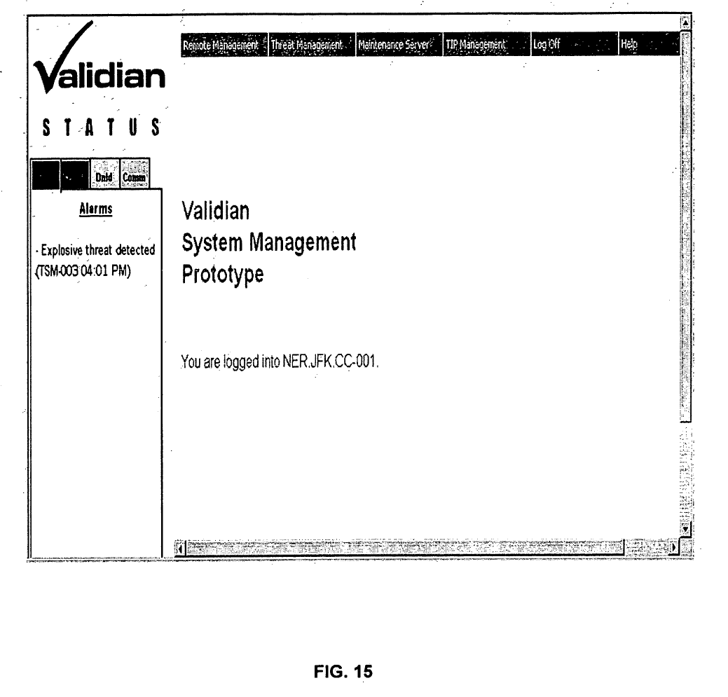

FIG. 15 is an illustration of an exemplary user interface for the threat scanning machine management system showing the main menu screen. In particular, the main menu comprises Remote Management, Threat Management, Maintenance Server, TIP Management, Log Off, and Help choices. There is also shown in FIG. 15 a tab style user interface element comprises the tabs choices of Alarms, Events, Dnld (an abbreviation for download), and Comm (an abbreviation for communications).

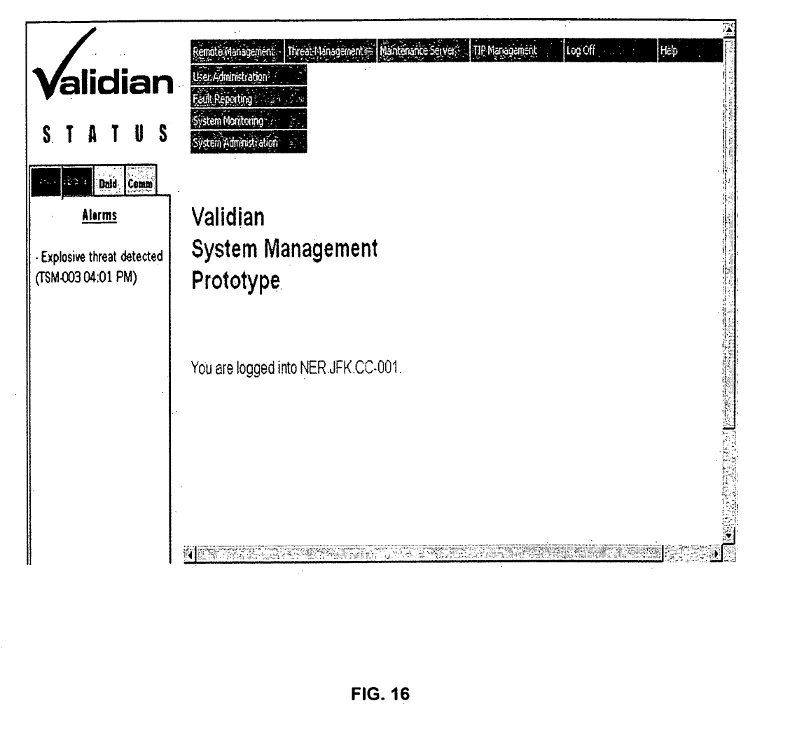

If the user selects the Remote Management menu choice, the Remote Management menu will be displayed. FIG. 16 is an illustration of an exemplary user interface for the threat scanning machine management system showing the items available under the Remote Management menu choice. In particular, the Remote Management menu comprises User Administration, Fault Reporting, System Monitoring, and System Administration choices.

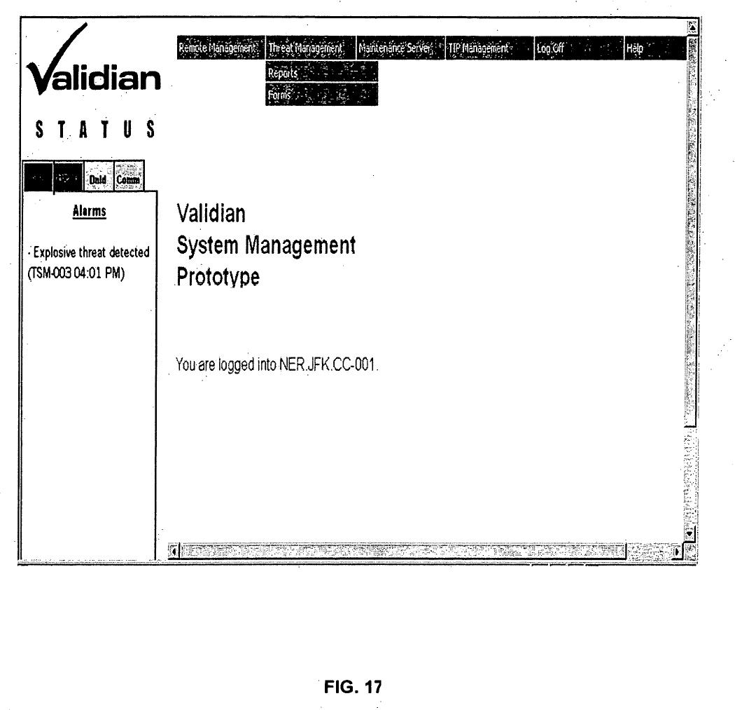

If the user selects, from the main menu, the Threat Management menu choice, the Threat Management Menu will be displayed. FIG. 17 is an illustration of an exemplary user interface for the threat scanning machine management system showing the items available under the Threat Management menu choice. In particular, the Threat Management menu comprises Reports and Forms menu choices.

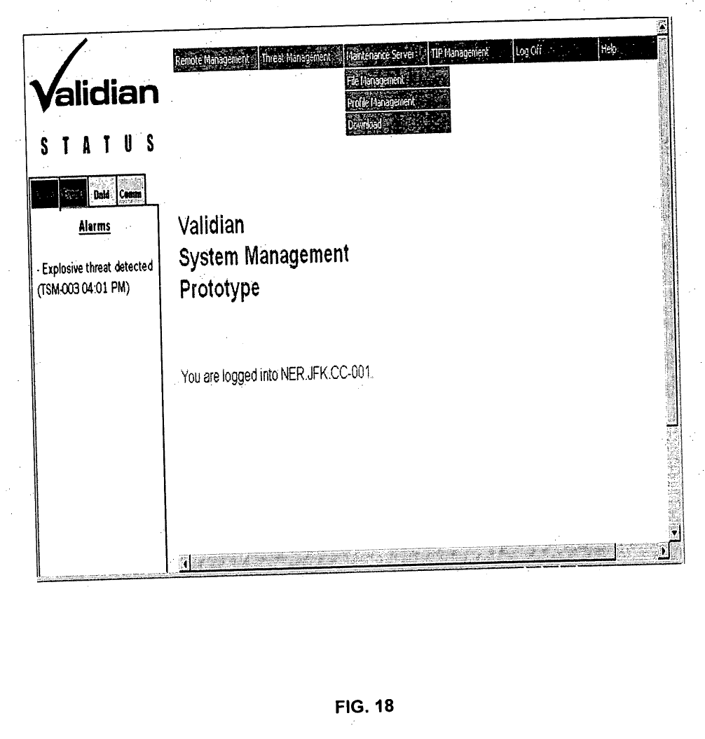

If the user selects, from the main menu, the Maintenance Server menu choice, the Maintenance Server menu will be displayed. FIG. 18 is an illustration of an exemplary user interface for the threat scanning machine management system showing the items available under the Maintenance Server menu choice. In particular, the Maintenance Server menu comprises File Management, Profile Management, and Download menu choices.

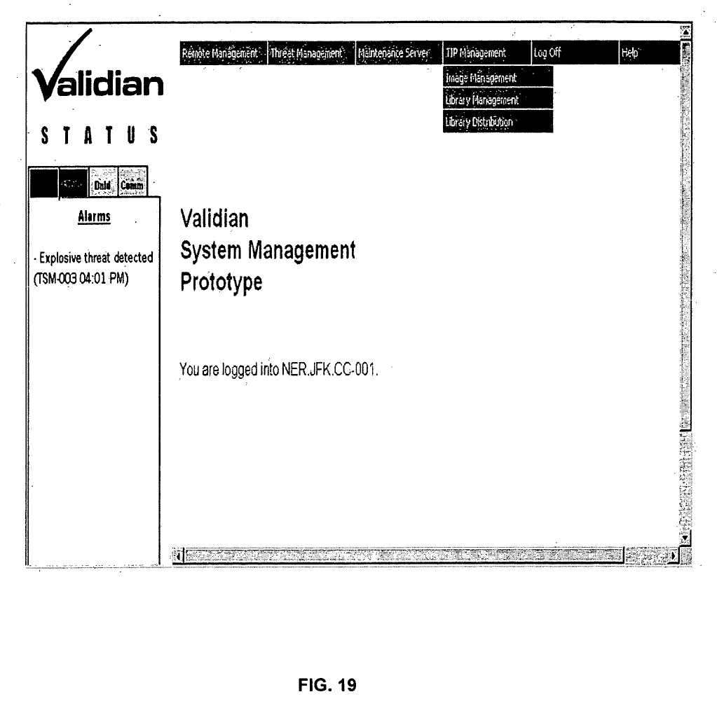

If the user selects, from the main menu, the TIP Management menu choice, the TIP Management menu will be displayed. FIG. 19 is an illustration of an exemplary user interface for the threat scanning machine management system showing the items available under the TIP Management menu choice. In particular, the TIP management menu comprises Image Management, Library Management, and Library Distribution menu choices.

If the user sects, from the main menu, the Log Off menu choice, the user will be logged of the system.

If the user selects, from the main menu, the Help menu choice, the user will be presented with information on how to operate the threat scanning machine management system.

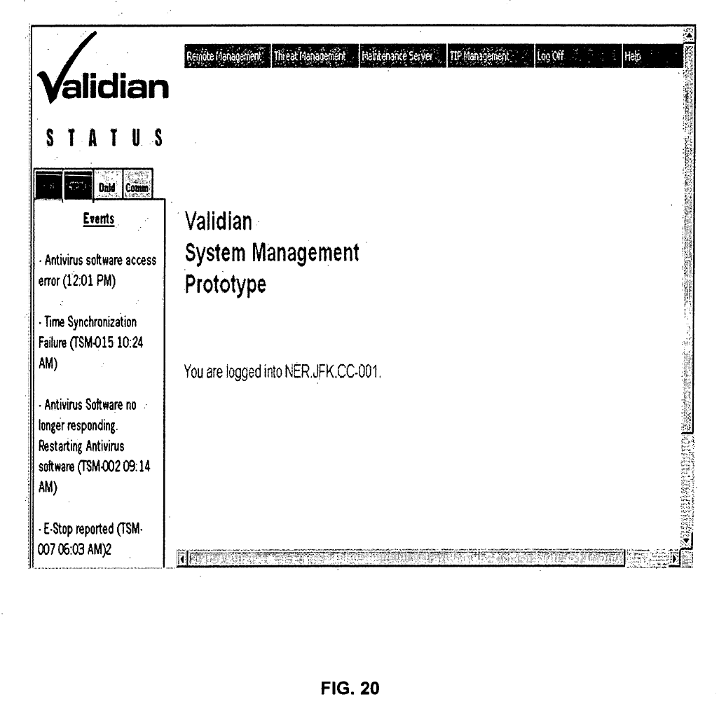

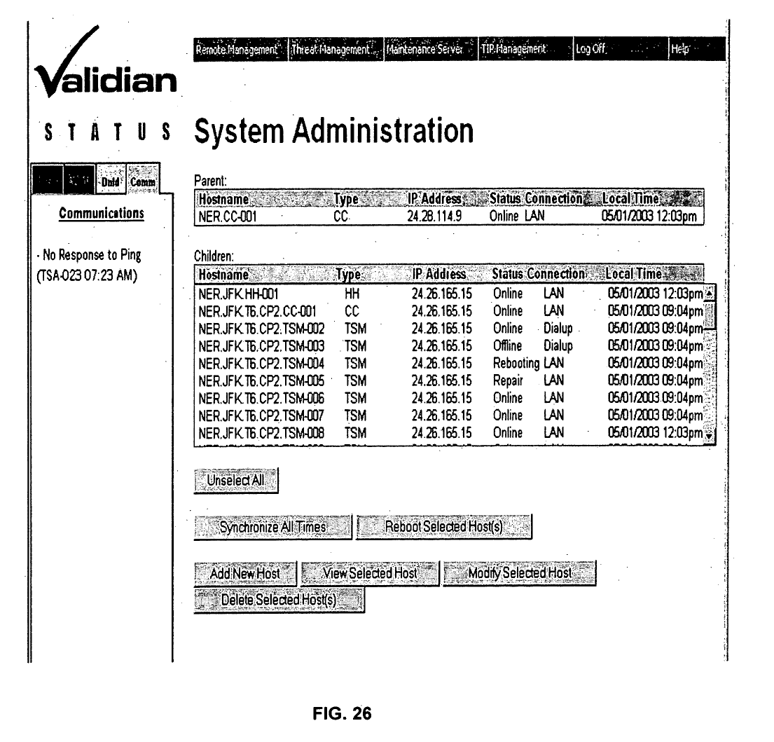

FIG. 20 shows an exemplary Events tab screen. FIG. 26 shows an exemplary Comm (short for communications) tab screen. The tab screens allow the operator to quickly ascertain the status of important system functions.

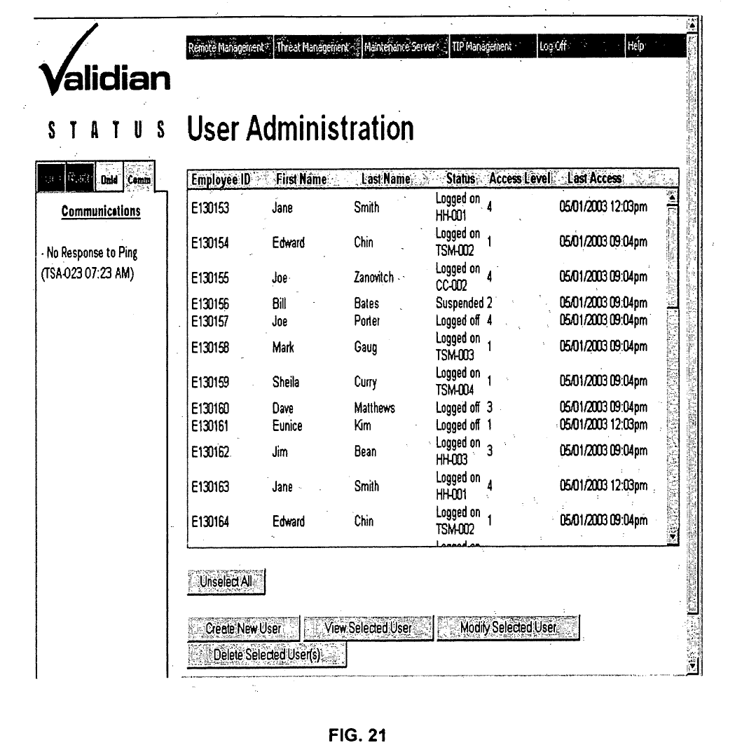

Returning to the Remote Management menu of FIG. 16, if the user selects the User Administration menu choice, the User Administration screen will be displayed. FIG. 21 is an illustration of an exemplary user interface for the threat scanning machine management system showing the User Administration screen.

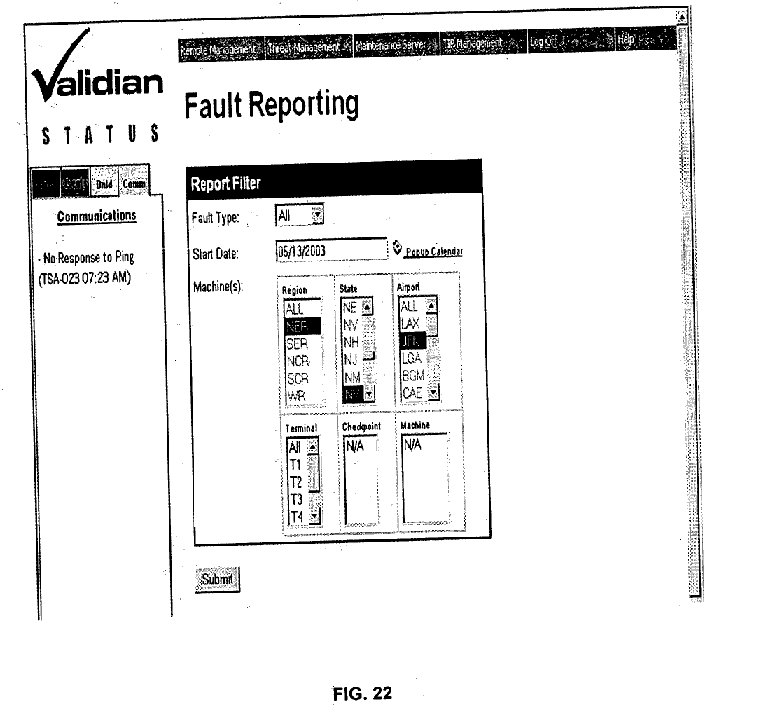

If the users selects, from the Remote Management menu, the Fault Reporting menu choice, the Fault Reporting dialog will appear. FIG. 22 is an illustration of an exemplary user interface for the threat scanning machine management system showing the Fault Reporting selection dialog interface.

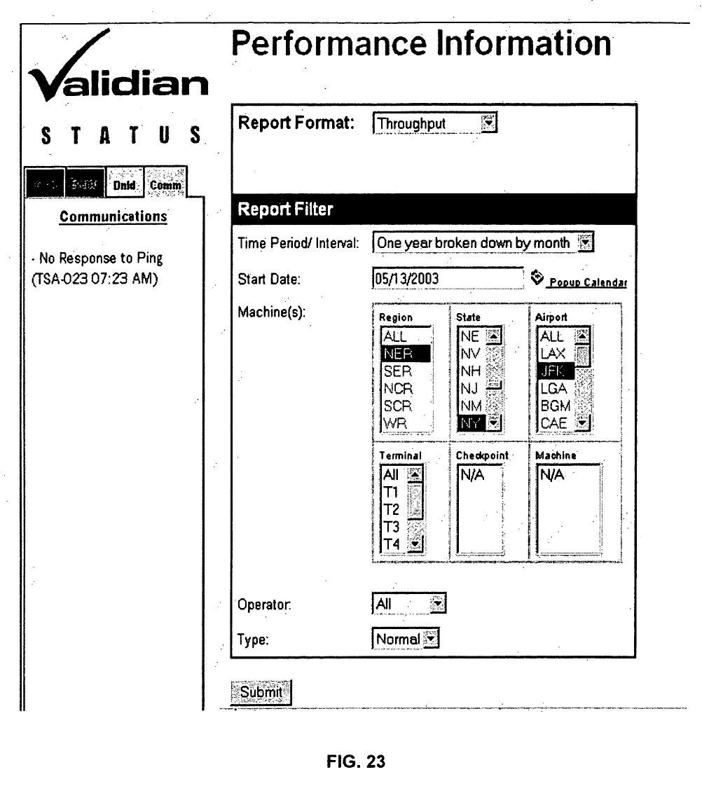

If the user selects, from the Remote Management menu, the System Monitoring menu choice, the Performance Information dialog will be displayed. FIG. 23 is an illustration of an exemplary user interface for the threat scanning machine management system showing the Performance Information dialog.

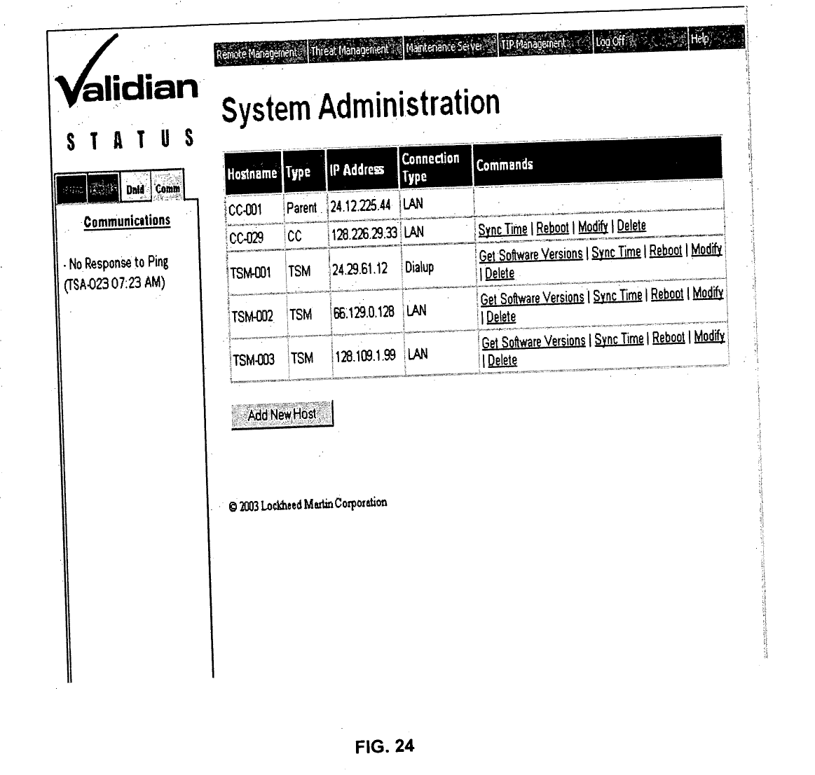

If the user selects, from the Remote Management menu, the System Administration menu choice, the System Administration menu will be displayed. FIG. 24 is an illustration of an exemplary user interface for the threat scanning machine management system showing the System Administration screen.

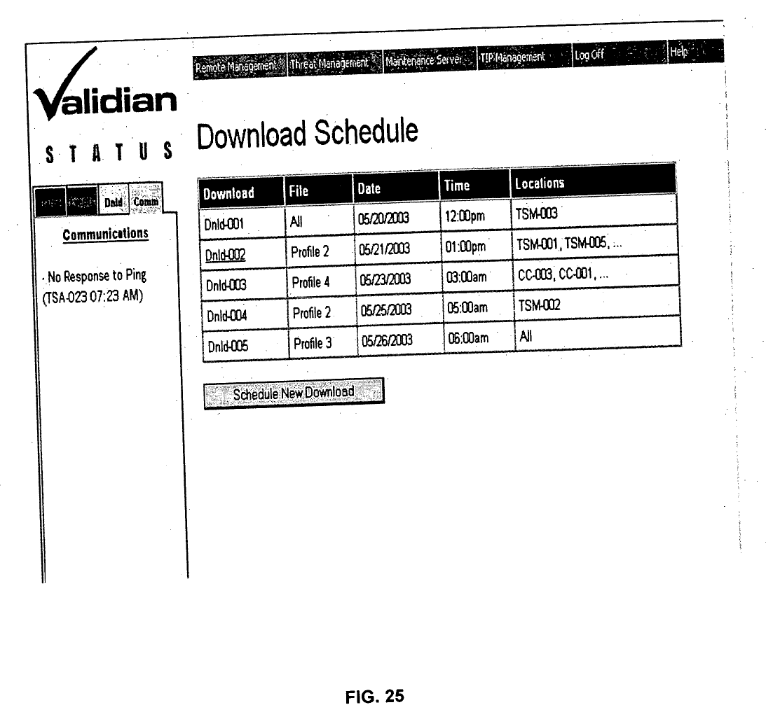

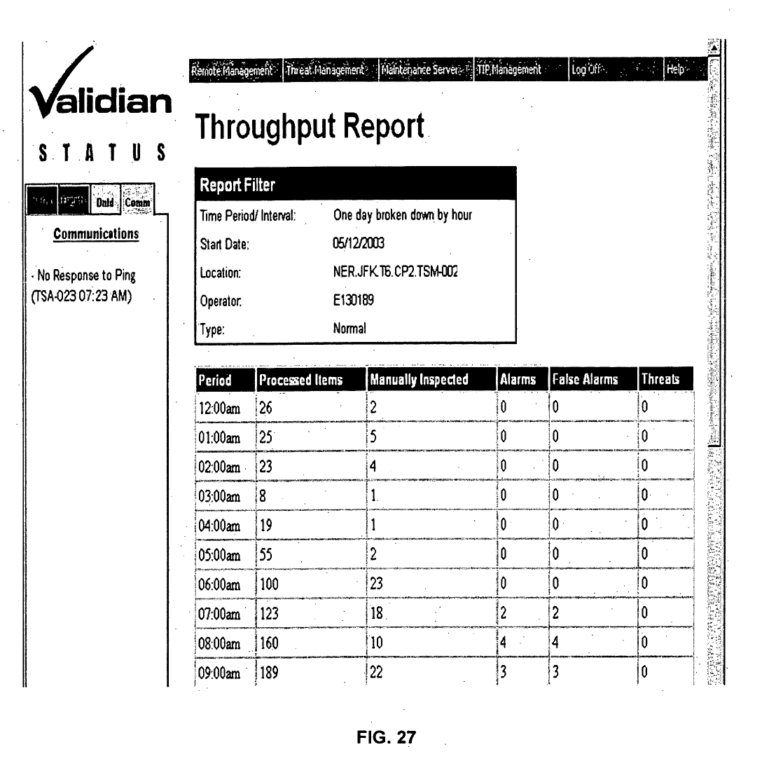

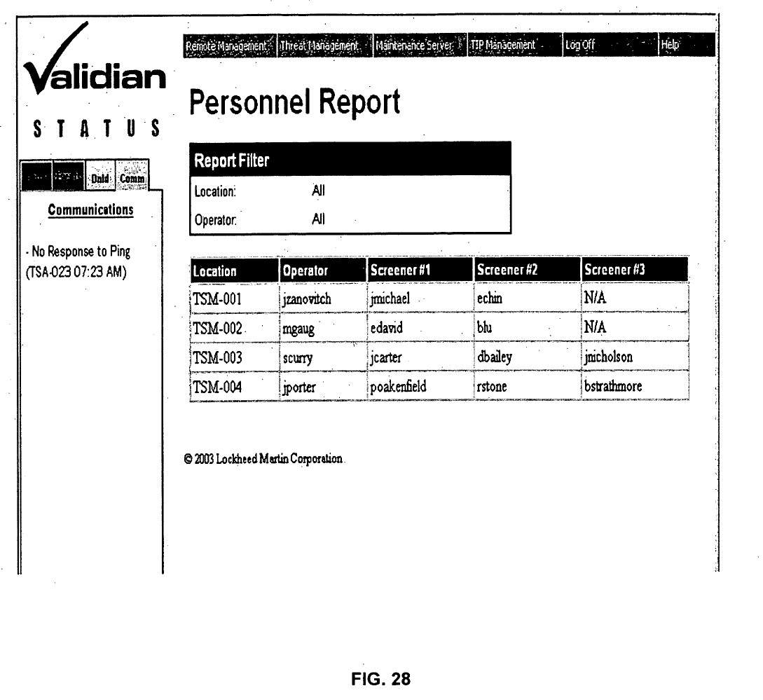

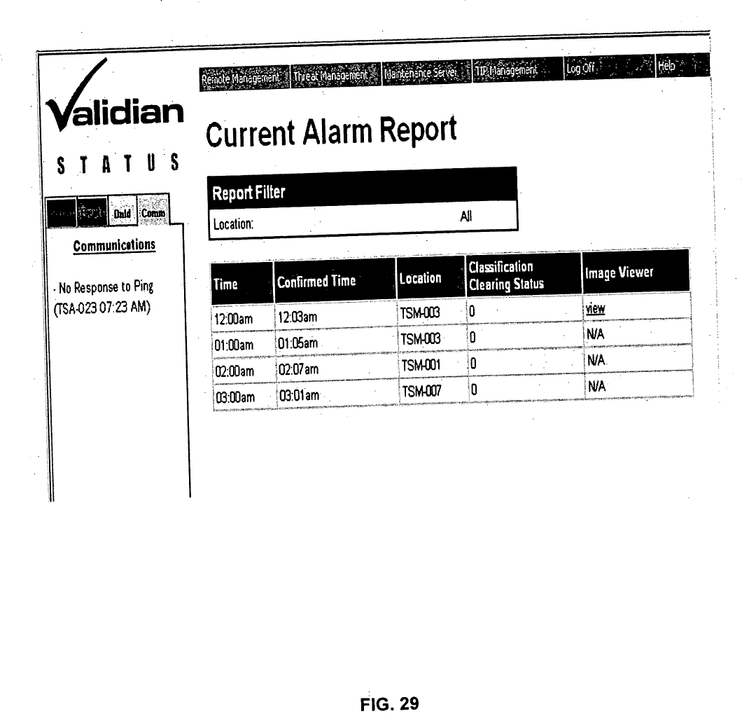

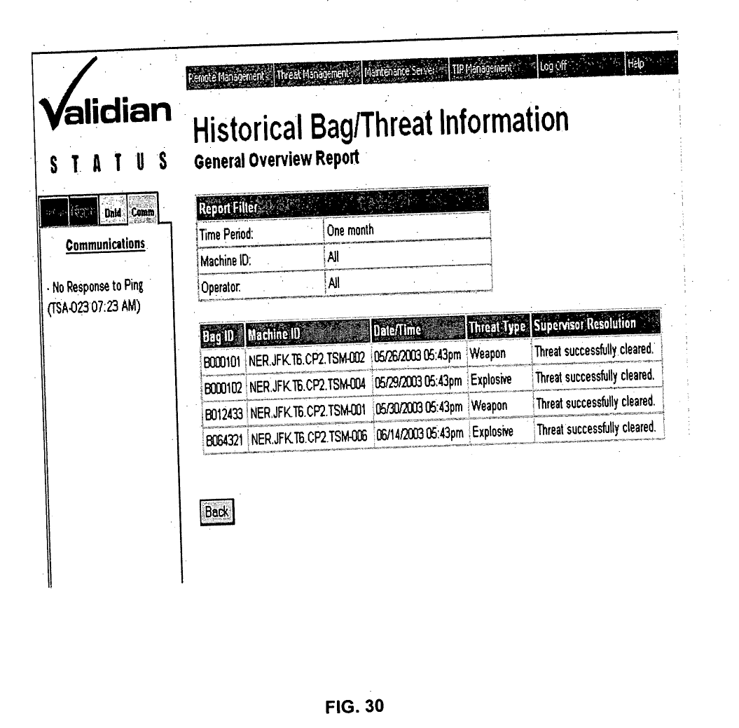

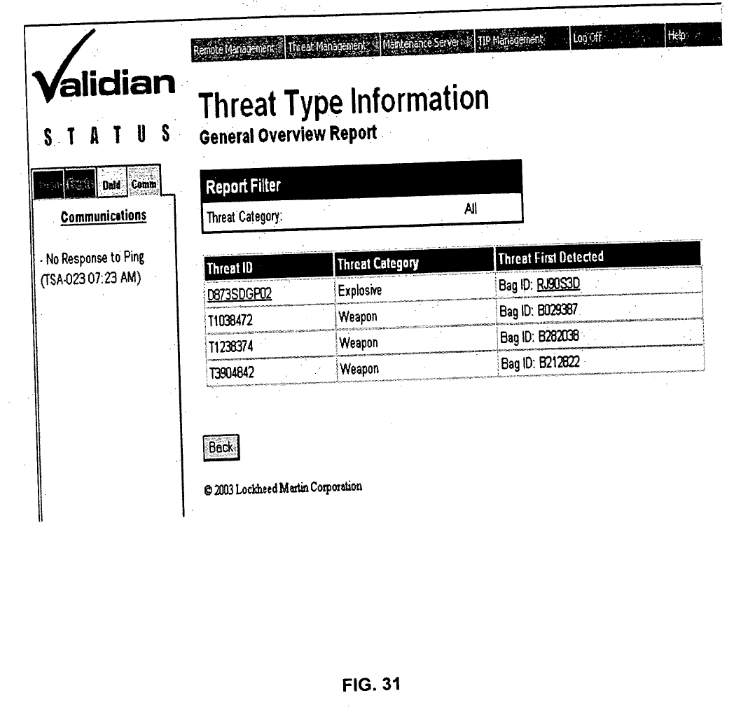

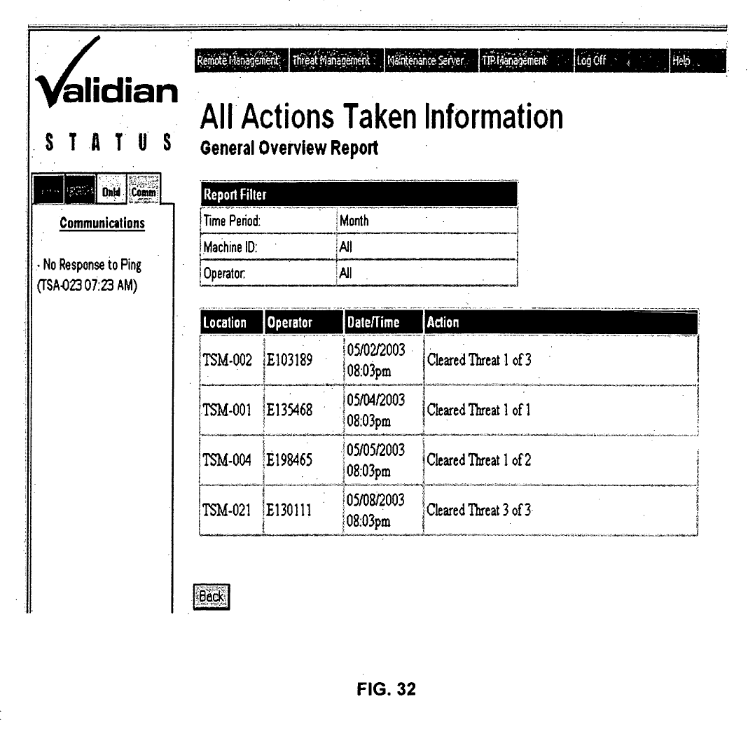

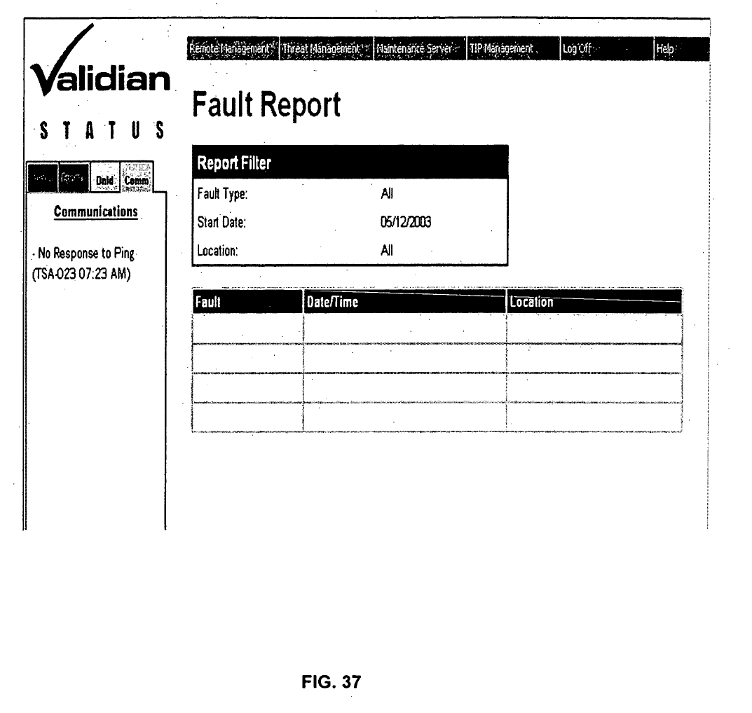

Turning now to the Threat Management menu shown in FIG. 17, if the user selects, from the Threat Management menu, the Reports menu choice, the reports selection will be displayed. Examples of the types of reports available include the Download Schedule shown in FIG. 25, the Throughput Report shown in FIG. 27, the Personnel Report shown in FIG. 28, the Current Alarm Report shown in FIG. 29, the Historical Bag/Threat Information Report shown in FIG. 30, the Threat Type Information Report shown in FIG. 31, the Fault Report shown in FIG. 37 and the All Actions Taken Information Report shown in FIG. 32.

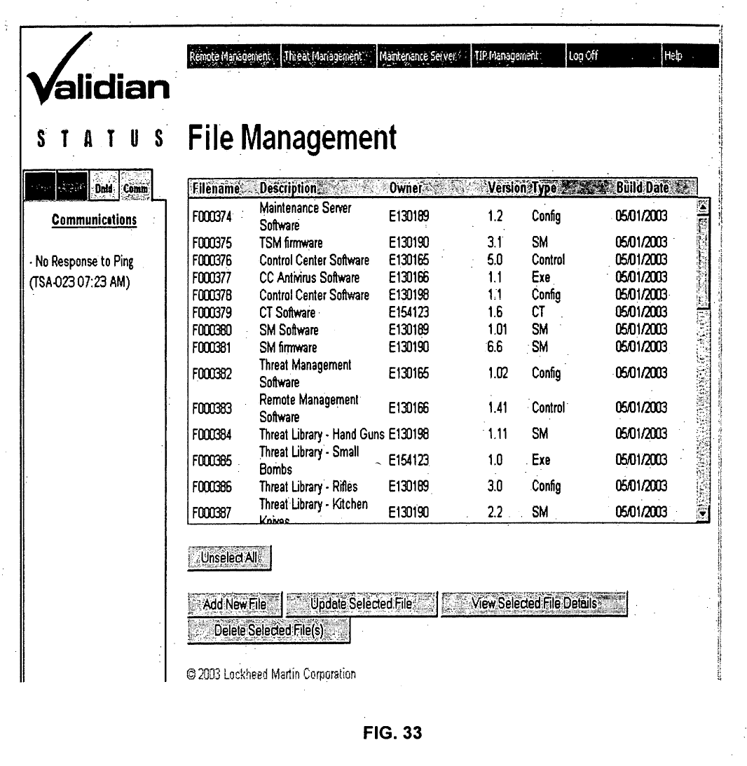

Turning now to the Maintenance Server menu shown in FIG. 18, if the user selects from the Maintenance Server menu, the File Management menu choice, the File Management screen will be displayed. FIG. 33 is an illustration of an exemplary user interface for the threat scanning machine management system File Management screen. From the File management screen, the user can add files.

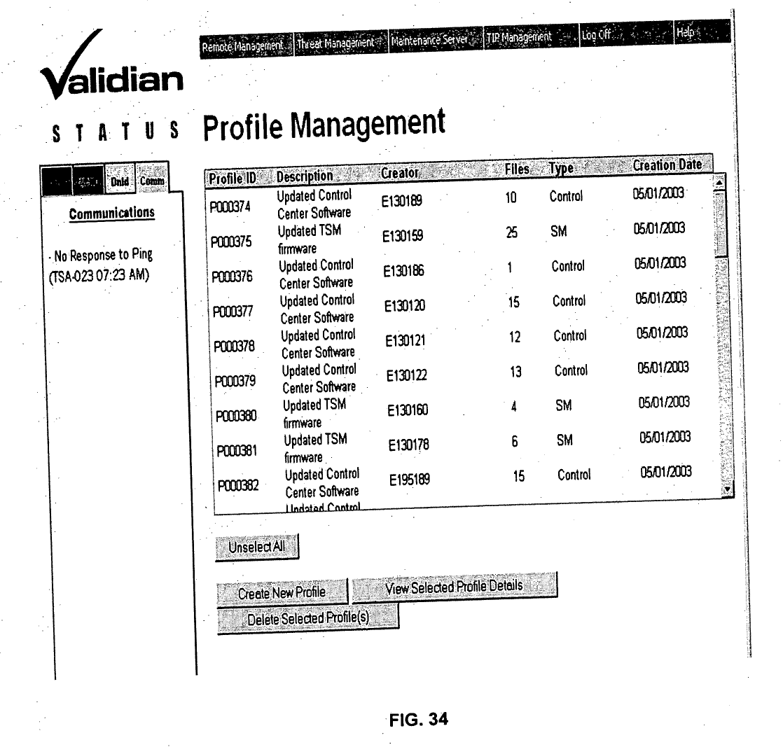

If the user selects, from the Maintenance Server menu, the Profile Management menu choice, the Profile Management screen will be displayed. FIG. 34 is an illustration of an exemplary user interface for the threat scanning machine management system showing the Profile Management screen. From the Profile Management screen, the user can define a profile comprising one or more files that require downloading. The profile is a way of bundling the files that require downloading together.

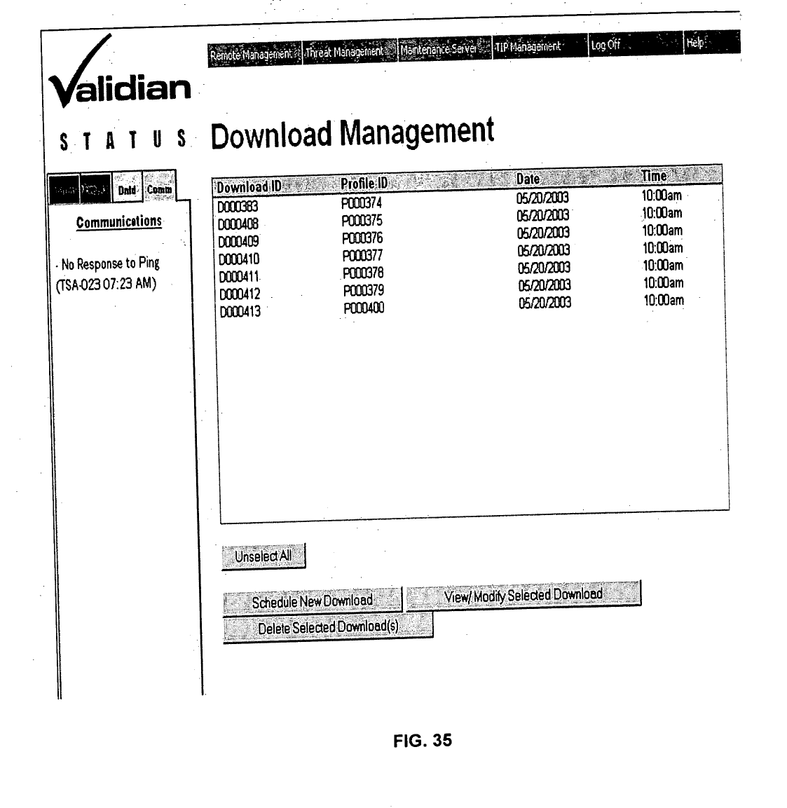

If the user selects, from the Maintenance Server menu, the Download menu choice, the Download Management screen will be displayed. FIG. 35 is an illustration of an exemplary user interface for the threat scanning machine management system showing the Download Management screen. Using the Download Management screen, the user can schedule a download of a previously defined profile.

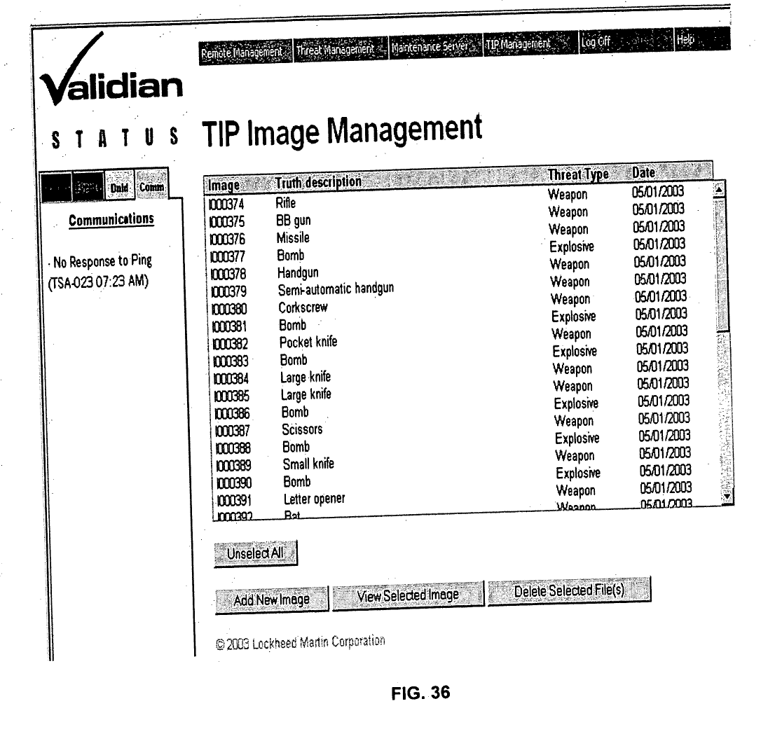

Turning now to the TIP Management menu shown in FIG. 19, if the user selects the Image Management option, the TIP Image Management screen will be displayed. FIG. 36 is an illustration of an exemplary user interface for the threat scanning machine management system showing the TIP Image Management screen.

FIG. 37 shows an exemplary Fault Report screen. There are no faults shown in this example. However, if faults were present for the report criteria specified, such faults would be displayed in the table along with the pertinent fault details.

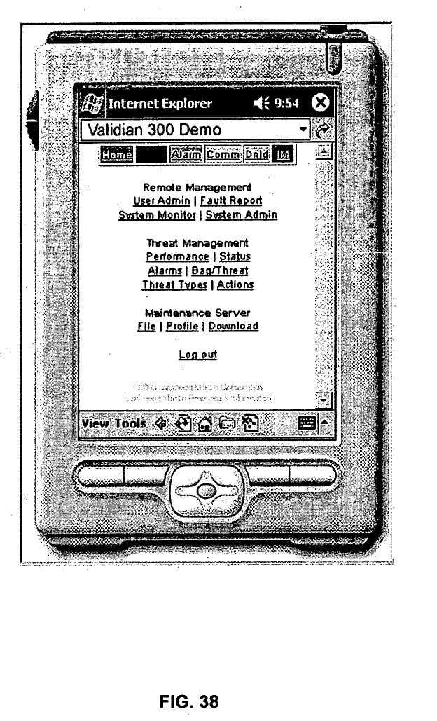

FIG. 38 shows an exemplary threat scanning machine management system user interface that has been adapted to be displayed on a handheld computer, laptop computer, or the like. In particular, FIG. 38 is presented to show the main menu screen on a simulated handheld device. While the other screens are not shown on a handheld device is should be appreciated that the entire threat management system user interface may be adapted to use on handheld computer, laptop computer, portable computer, network enabled communications device, or any type of portable computing device.

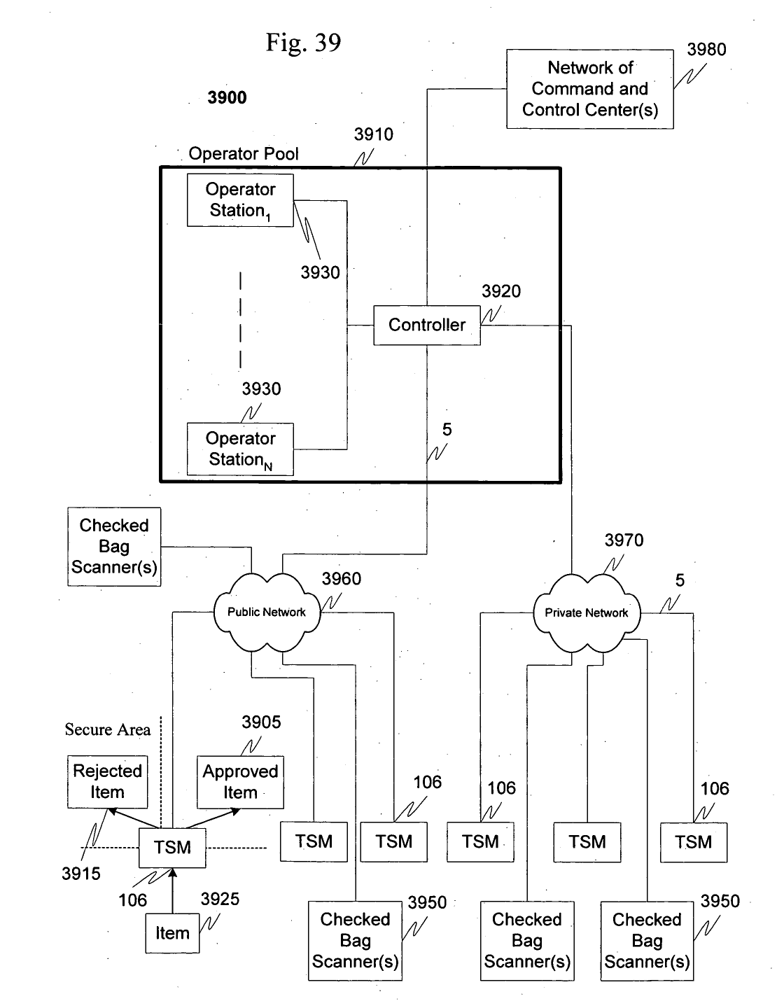

FIG. 39 illustrates an optional exemplary embodiment that can be used as an independent architecture and methodology or in conjunction with the threat scanning machine management system 100. In particular, the pooled operator configuration 3900 comprises one or more operator pools 3910, that can be remotely located from the one or more threat scanning machines, with the one or more operator pools 3910 each comprising one or more operator stations 3930 connected to a controller 3920. Each operator pool 3910 is connected to one or more command and control centers within the network of command and control centers 3980 (as illustrated in FIG. 1). The operator pool 3910 is connected, via link 5, to one or more of a public network 3960 and/or a private network 3970, which are each in turn connected to one or more threat scanning machines 106 and checked bag scanners 3950. However, and in general, any threat scanning machine that generates an image that can be viewed and/or manipulated by one or more of the operator stations can be used with equal success. For example, an operator can rotate a received image and/or “clear” an image that was highlighted as a threat, and/or forward information back to the threat scanning machine to assist a manual inspector with identification of the location of the suspected threat. The communications between the connected elements can be encrypted or otherwise secured as well as redundant to help ensure reliability. While in this illustrative embodiment one operator pool 3910 is shown being connected via a distributed network to a particular set of threat scanning machines 106 and/or checked bag scanners 3950, it is to be appreciated that the system can be reconfigured in any manner based on, for example, networking capabilities, commands received from a command and control center, or, for example, be dynamically reconfigured based on network outages, load sharing requirements, security reasons, or the like. For example, each threat scanning machine 106 can be connected to one or more of the public network 3960 and the private network 3970, which in turn can be connected to one or more operator pools 3910. Likewise, each of the checked bag scanners 3950 can be connected to one or more of the public network 3960 and/or the private network 3970, which in turn can be connected to one or more operator pools 3910. The operator stations 3930 comprise, for example, a computing device adapted to display images corresponding to scanned items and an input device allowing an operator at the operator station 3930 to manipulate the images and enter information into the system, such as threat status, commands or the like. The operator station 3930 can also be equipped with security features such as a login protocol, timekeeper functionality, a messaging service that allows collaboration with, for example, other operators, and the like.

The operator pool 3910 comprises a controller 3920 that provides, for example, routing of data such as one or more images of scanned items from one or more of the threat scanning machines 106 and the checked bag scanner 3950. The controller can also forward, at the direction of a command and control center, TIPs to one or more operator stations 3930. The routing of the images by the controller 3920 is governed by one or more command and control centers within the network of command and control centers 3980. For example, profiles can be established that govern the routing of images form specific threat scanning machines and/or checked bag scanners 3950 to one or more operator pools 3910, and may further specify one or more particular operator stations 3930 within a particular operator pool 3910. Thus, it could be possible to have the same image being evaluated by a plurality of operators and/or supervisors that are scanning for threats or other objects.

The threat scanning machines 106 and/or checked bag scanners 3950 can also be directly connected to one or more operator pools and/or operator stations 3930. In this illustrative exemplary embodiment, the image resides on the threat scanning machine 106 and/or checked bag scanner 3950 until an instruction is received from the controller 3920 to forward the image. For example, an operator station 3930 can be assigned an IP address and the image forwarded to that IP address. In addition to the controller 3920 being associated with a particular operator pool, there can be a “global” controller or hierarchy of controllers (not shown) that control image routing to groups of operator pools or sub-group of controllers that handle further distribution. Alternatively still, each image could pass through the controller 3920 as appropriate.

In addition to controlling the images forwarded to the one or more operator stations 3930, the controller 3920 can also regulate and provide the operator stations 3930 with access to one or more of the of the threat scanning machines 106 and the checked bag scanners 3950. Again, the access to the threat scanning machines 106 and checked bag scanners 3950 can be regulated by a command and control center within the network of command and control centers 3980 based on, for example, a profile. This profile, in cooperation with a command and control center, is capable of authorizing in a real-time manner, or in an automated or semi-automated manner, a request by an operator 3930 for permission to contact one or more of the threat scanning machines 106 and checked bag scanners 3950. Upon authorization from a command and control center within the network of command and control centers 3980, the operator 3930 is then allowed a certain amount of access to one or more of the threat scanning machines 106 and the checked bag scanners 3950. For example, the operator can request a rescanning and/or re-orientation and rescanning of an item. Alternatively, for example, the request by an operator to access control of a threat scanning machine 106 or checked bag scanner 3950 can trigger an alert and simultaneously request peer or supervisory review of the same item. This redundant review can be accomplished with or without the knowledge of the original operator. For example, if multiple operators are reviewing the image, the status of each operator's review of the image could be provided to appropriate operators and/or a supervisor. Alternatively, or in addition, statistical information such as the number of items scanned, the time taken for each scan, the number of items identified as being a threat, or in general any information relating to the threat scanning machine network and/or pooled operator configuration can be compiled by one or more of the command and control centers and displayed to the appropriate individual(s).

In addition to regulating the distribution of images from one or more of the threat scanning machines 106 and checked bag scanners 3950 to an operator, the network of command and control centers 3980 is capable of reconfiguring the pooled operator configuration 3900 to, for example, perform load balancing, route images and/or TIPs to one or more different operator pools 3910, that may or may not be collocated with a particular threat scanning machine 106 or checked bag scanner 3950, or the like. For example, an operator pool 3910 could be located on the same premises, for example, in the same airport, as the associated threat scanning machines 106 and checked bag scanners 3950. However, the operator pool 3910 need not be associated with a specific group of threat scanning machines 106 and/or checked bag scanners 3950. Rather, the operator pool 3910 can, in general, receive images from any location, be it an airport, train station, building security facility, or the like, either nationally or internationally, and can be configured so as to provide a collaborative effort and more unified approach to detecting threats. For example, it may be advantageous to have a group of operators scan all the items associated with passengers for a particular flight. In this illustrative example, the controller 3920, in cooperation with the network of command and control centers 3980 and the threat scanning machines 106 and/or checked bag scanners 3950, can monitor a relationship between a scanned item and the passenger, i.e., owner, of the item. This relationship could be tracked by a bar code, radio frequency identification (RFID) device, or the like, associated with the item and read by the threat scanning machines 106 and/or checked bag scanners 3950. Thus, when the item is scanned, the image can be forwarded to a particular operator and/or operator pool based on, for example, flight information, passenger information, destination information, airline information, nationality information, or the like.

By providing operator pools, a more conducive environment can be provided to the operators for reviewing of the images. For example, operator profiling can be reduced or eliminated, operators can take breaks and operators can request assistance from other operators within the pool, a supervisor and/or from one or more command and control centers without causing screening delays at a security check point. Similarly, operator pools could help reduce expenses at smaller facilities by centralizing an operator pool that may not need to be geographically collocated with that particular facility. Additionally, for example, by removing the operators from the environment where the physical machines are and in the case of carry-on baggage, the passengers as well, “Operator profiling” can be reduced in that profiling of passengers based on things like race, dress, etc, is reduced if not eliminated, there are overall less distractions; it removes knowledge of TIPs; today, if a TIP image is given to the carry-on operators, they pretty much know it is a TIP image because if they put a TIP inside the existing image produced by the machine, it stands out too clearly and a “canned” image in the bag, it is obvious to the operator that it is not the image of the bag that just got loaded; it reduces operator resources by removing operator down or slow times (if 5 machine operators are 80% busy today, the job can be done with, for example, 4 centralized operators); and there less overhead for taking breaks or shift changes.

By utilizing the network of command and control centers 3980 to route images, the pooled operator configuration 3900 could also be used to perform training of new operators. For example, one or more “real-life” images can be routed in parallel to, for example, a training operator pool (not shown) that could also receive TIPs, so that operators in training will gain more familiarity with the actual threat scanning process. The system can also use this parallel architecture capability to perform, for example, redundant checking of images by forwarding, for example, the same image to one or more operator stations 3930 within one or more operator pools 3910. For example, the network of command and control centers 3980 could specify that each image is to be “approved” by a certain number of operators before the bag is allowed to pass through a particular security check point. Only upon approval by this predetermined number of operators, will the bag be allowed to pass through security. For example, this could be useful during times of heightened security or in high risk areas.

In operation, an image is forwarded from one or more of the threat scanning machines 106 and the checked bag scanners 3950, via a distributed network, links 5, and controller 3920, and under the supervision of the network of command and control center 3980, to one or more operator stations 3930 within an operator pool 3910. The operator 3930 can view the image, approve the image, request additional information, such as a rescanning of the scanned article, raise an alarm, request a second review of the image, or the like. Upon approval of the screened item, by one or more operators, an indication can be forwarded to the appropriate threat scanning machine 106 or checked bag scanner 3950 indicating that the screened article can be allowed through the security checkpoint. For example, the threat scanning machine 106 or checked bag scanner 3950 can associate an “approved” designation with the scanned article. For example, and as previously discussed, if the scanned item has an identification associated therewith, such as a bar code, RFID tag, or the like, an indication of the approval state can be associated with the scanned item. For example, if an RFID tag is associated with the scanned item, a routing machine and conveyor belt (not shown) can sort scanned items 3925 based on the approval status and, for example, route “approved” scanned items 3905 to a passenger pick-up location and alternatively route “rejected” scanned items 3915 to a secure area for manual/human inspection.

In addition to the scanning capabilities of the pooled operator configuration 3900, the system also makes it easier to monitor operator performance, throughput and testing. For example, TIPs can be forwarded to one or more operator stations 3930 for testing and monitoring of how an operator performs. These TIPs may or may not contain a representation of a threat. For example, the network of command and control centers 3980 can monitor an operator's interactions with the TIPs, such as how many times the operator rotated, reviewed, re-reviewed the image, and the like. The network of command and control centers 3980 could also monitor the amount of time it took for the operator to reach a determination regarding a security threat, which could be used to, for example, score an operator's performance.

Additionally, by having the operator(s) in a pooled configuration, the operator(s) is not aware of the origin of the image and thus collusion between an operator and the passenger can be reduced.

It should be appreciated that the systems in accordance with this invention are capable of processing the image(s) in real-time, for example while the item for inspection is still on the scanning device, or near real-time. When training, not only TIP images could be included in the training exercise, but also “live” images, presuming that the “live” image is also being analyzed by someone not in training. TIP or live images can also be managed so as to keep operators busy so that the operator has a continual flow of images and TIP images can be utilized to keep the operator on their toes to ensure that they do see threats in images more frequently than what is in the actual items being reviewed.

Additionally, the system can take advantage of “Vertical” verification. This is where images are sent “vertically” for requested verification (“Call for help”) to someone more senior or where the system automatically sends occasional images vertically for verification. This can be advantageous where, for example, there are less experienced operators, more experienced operators and supervisors. Furthermore, provided the appropriate networking is in place, one operator pool can serve as a backup for another operator pool. For example, if the operators at Airport A go on strike, the images could be sent to the operators for Airport B.

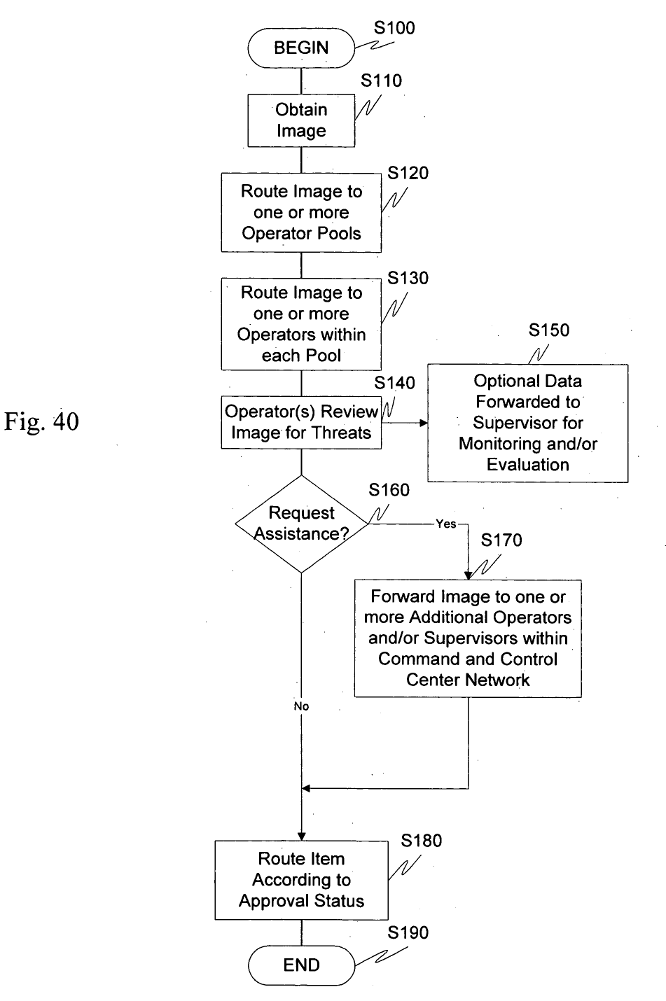

FIG. 40 outlines an exemplary method of the operation the pooled operator configuration. In particular, control begins at step S100 and continues to step S110. In step S110, an image corresponding to a scanned item at a threat scanning machine or a checked bag scanner is obtained. Next, in step S120, the image is routed to one or more operator pools. Then, in step S130, the image is routed to one or more operators within each pool. Control then continues to step S140.

In step S140, the operator(s) review the image for threats. Optionally, in step S150, data can be forward to, for example, a supervisor for such functions as monitoring and/or evaluation of the operator's review process.

In step S160, a determination is made whether the operator has requested assistance in reviewing the image. Also, the system could automatically forward the image to one or more other entities for verification and/or training as appropriate. If assistance is requested, control continues to step S170, otherwise control jumps to step S180. In step S170 the image is forwarded for review by one or more additional operators, which can be either within the same operator pool or in another operator pool, and/or supervisors within the network of command and control centers. Control then continues to step S180.

In step S180, the item is routed according to it approval status. For example, as previously discussed, the approval status can govern whether items are routed to a secured holding area or are returned to, for example, a passenger. Control then continues to step S190 where the control sequence ends.

As shown in the above figures, the threat scanning machine management system and pooled operator configuration can be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic device such as a PLD, PLA, FPGA, PAL, or the like. In general, any process capable of implementing the functions described herein can be used to implement the system and methodology according to this invention.

Furthermore, the disclosed system may be readily implemented in software using object or object-oriented software development environments that provide portable source code that can be used on a variety of computer platforms. Alternatively, the disclosed system may be implemented partially or fully in hardware using standard logic circuits or a very large-scale integration (VLSI) design. Other hardware or software can be used to implement and supplement the systems in accordance with this invention depending on the speed and/or efficiency requirements of the system, the particular function, and/or a particular software or hardware system, microprocessor, networking, or microcomputer system being utilized. The system illustrated herein can readily be implemented in hardware and/or software using any known or later developed systems or structures, devices and/or software by those of ordinary skill in the applicable art from the functional description provided herein and with a general basic knowledge of the computer and network communication arts.

Moreover, the disclosed methods may be readily implemented in software executed on programmed general-purpose computer, a special purpose computer, a microprocessor, or the like. In these instances, the systems and methods of this invention can be implemented as a program embedded on personal computer such as JAVA® or Common Gateway Interface (CGI) script, as a resource residing on a server or graphics workstation, as a routine embedded in a dedicated security system, or the like. The system can also be implemented by physically incorporating the system and method into a software and/or hardware system, such as the hardware and software systems of a security network.

It is, therefore, apparent that there is provided in accordance with the present invention, systems and methods for managing threat scanning machines and pooled operators. While this invention has been described in conjunction with a number of embodiments, it is evident that many alternatives, modifications and variations would be or are apparent to those of ordinary skill in the applicable arts. Accordingly, applicants intend to embrace all such alternatives, modifications, equivalents and variations that are within the spirit and scope of this invention.

1. A security system comprising:
a controller adapted to receive and route images corresponding to items scanned at one or more scanning machines; and
one or more remote operator pools, each remote operator pool having one or more operator stations, the operator stations adapted to receive the images for threat assessment.

2. The system of claim 1, further comprising a profile that specifies the routing of the images based on one or more of passenger identity, destination information, flight information, item identification, load balancing information, operator availability information, image origination information and scanning machine information.

3. The system of claim 1, wherein the security system is adapted to cooperate with a network of command and control centers.

4. The system of claim 1, wherein the one or more scanning machines are one or more of threat scanning machines and checked baggage scanners.

5. The system of claim 1, further comprising an item routing system adapted to route items at least based on the threat assessment.

6. The system of claim 1, wherein the images can be routed in parallel to one or more operator stations.

7. The system of claim 1, wherein the operator station comprises a display device that is adapted to at least display the images and provide an input means.

8. The system of claim 1, wherein the controller is adapted to route the images to one or more operator pools used for training.

9. The system of claim 1, wherein the controller is adapted to allow an operator station to communicate information to a scanning machine.

10. The system of claim 9, wherein the information is at least one of threat status information and scanning machine control instructions.

11. The system of claim 1, wherein the one or more scanning machines are adapted to associate threat status information with a scanned item.

12. A method of assessing threats comprising:
forwarding an image corresponding to a scanned item to one or more operator stations within one or more remote operator pools; and
receiving information regarding a threat assessment of the scanned item.

13. The method of claim 12, further comprising routing the scanned item based on the threat assessment.

14. The method of claim 13, wherein the routing of the images is based on one or more of passenger identity, destination information, flight information, item identification, load balancing information, operator availability information, image origination information and scanning machine information.

15. The method of claim 12, further comprising forwarding the image to one or more additional operator stations.

16. The method of claim 12, further comprising forwarding the image to one or more operator stations used for training.

17. The method of claim 12, further comprising monitoring an operator's performance at an operator station.

18. The method of claim 12, further comprising communicating with a network of command and control centers to exchange information regarding threat assessment.

19. A security system comprising:
means for receiving and routing images corresponding to items scanned at one or more scanning machines; and
one or more remote operator pools, each remote operator pool having one or more operator stations, the operator stations adapted to receive the images for threat assessment.

20. The system of claim 19, further comprising means for specifying the routing of the images based on one or more of passenger identity, destination information, flight information, item identification, load balancing information, operator availability information, image origination information and scanning machine information.
